(19) United States
(12) Patent Application Publication
(10) Pub. No.: US 2025/0016774 A1
(43) Pub. Date: Jan. 9, 2025

(54) INDICATION METHOD AND APPARATUS

(71) Applicant: FUJITSU LIMITED, Kawasaki-shi Kanagawa (JP)

(72) Inventors: Xin WANG, Beijing (CN); Gang SUN, Beijing (CN); Jian ZHANG, Beijing (CN)

(73) Assignee: FUJITSU LIMITED, Kawasaki-shi Kanagawa (JP)

(21) Appl. No.: 18/897,628

(22) Filed: Sep. 26, 2024

Related U.S. Application Data
(63) Continuation of application No. PCT/CN2022/084525, filed on Mar. 31, 2022.

(51) Int. Cl. H04W 72/20

(52) U.S. Cl. CPC H04W 72/20

(57) ABSTRACT

An indication apparatus includes: first processor circuitry configured to determine a first AI/ML module in a terminal equipment and/or a second AI/ML module in a network device are/is to be stopped; and a first transmitter configured to transmit to the network device a request for indicating to stop the first AI/ML module and/or the second AI/ML module.

### CROSS-REFERENCE TO RELATED APPLICATION

This application is a continuation application of International Application PCT/CN2022/084525 filed on Mar. 31, 2022, and designated the U.S., the entire contents of which are incorporated herein by reference.

### TECHNICAL FIELD

Embodiments of the present disclosure generally relate to the field of communications.

### BACKGROUND

This section introduces aspects that may facilitate better understanding of the present disclosure. Accordingly, the statements of this section are to be read in this light and are not to be understood as admissions about what is in the related art or what is not in the related art.

As a popular technique in recent years, artificial intelligence (AI) and/or machine learning (ML) have been applied to many application areas, such as image processing, video processing, natural language processing, automotive driving. The studies and discussions of applying AI/ML to 3GPP standards and its mobile systems are also becoming popular.

In the working groups of radio access network (RAN) in 3GPP, there is a study item “study on enhancement for data collection for NR and ENDC” in RAN3 in Rel-17. In Rel-18, it is endorsed as a work item. Besides, AI/ML for air interface has been widely discussed among companies. It was concluded as a study item in Rel-18 led by RAN1. Furthermore, it is foreseen that AI/ML will have great application prospects in future 6G standards and mobile networks.

AI/ML based approach can be applied to many use cases, such as channel state information (CSI) feedback, beam management, positioning, etc. As a substitute of related method, AI/ML can bring significant gain over related methods with regard to the KPIs like overhead reduction, performance enhancement, latency reduction etc.

Besides use cases studied in Rel-18, for Rel-18 onward releases in 5G era and future 6G standards, AI/ML has its potentials to be adopted in wider use case of air interface. From link level communication perspective, almost all signal processing functions of a communication link can be replaced by AI/ML processing.

Furthermore, for some layer 2 procedures, such as mobility, radio resource management, AI/ML also can outperform the existing methods benefitting from its super strong optimization capabilities. In future beyond 5G systems, AI native air interface is envisioned, and with the concept that one neural network (NN) is used to take the responsibilities of all communication functions at a transmitter side and the other paired neural network is used to take the responsibilities of all communication functions at a receiver side.

On the other hand, however, there are a lot of challenges and uncertainties of using AI/ML to air interface. For example, it is hard to know whether AI/ML is able to provide guaranteed quality of service (QOS) to a QoS sensitive traffic in all practical scenarios, since it is impossible to use field data collected from all deployed networks to train a neural network going to be used in either a terminal equipment side or a network device side.

For real time sensitive use cases, it is also not sure whether the neural network is able to always meet the latency requirement with a certain performance request. Another practical challenge comes from computation capability for supporting AI/ML processing. Computation capability of a device may bring restrictions to support multiple AI/ML functions at the same time.

Besides, from power consumption perspective, high power consuming caused by running AI/ML will be problematic when AI/ML is used in terminal equipment side. From the request of low-carbon communication, potential power increasing caused by widely applying AI/ML technique to mobile network systems also should be considered beforehand.

### SUMMARY

The summary is provided to introduce a selection of concepts in a simplified form that are further described below in detailed description. This summary is not intended to identify key features or essential features of the claimed subject matter, nor is it intended to be used to limit the scope of the claimed subject matter.

The inventors found that such kind of gains and pains from applications of AI/ML technique into 5G NR and 6G wireless systems, bring a request on how to intelligent synchronize the operations of AI/ML module(s) in a terminal equipment side and AI/ML module(s) in a network device side, in order to avoid performance degradation, reduce power consumption, relax computing power, and so on.

In order to solve at least part of the above problems, methods, apparatus, devices and computer programs are provided in the present disclosure. It may be appreciated that embodiments of the present disclosure are not limited to a wireless system operating in NR network, but could be more widely applied to any application scenario where similar problems exist.

In general, embodiments of the present disclosure provide an indication method and apparatus. It is expected to realize intelligent turn on and/or turn off the AI/ML modules in a terminal equipment side and the AI/ML modules in a network device side.

According to an aspect of the embodiments of this disclosure, there is provided an indication method. The method includes:
determining, by a terminal equipment, a first AI/ML module in the terminal equipment and/or a second AI/ML module in a network device are/is to be stopped; and
transmitting, by the terminal equipment to the network device, a request for indicating to stop the first AI/ML module and/or the second AI/ML module.

According to another aspect of the embodiments of this disclosure, there is provided an indication apparatus, the apparatus includes:
a first processing unit configured to determine a first AI/ML module in a terminal equipment and/or a second AI/ML module in a network device are/is to be stopped; and
a first transmitting unit configured to transmit to the network device a request for indicating to stop the first AI/ML module and/or the second AI/ML module.

According to another aspect of the embodiments of this disclosure, there is provided an indication method. The method includes:
determining, by a network device, a first AI/ML module in the terminal equipment and/or a second AI/ML module in the network device are/is to be stopped; and
transmitting, by the network device to the terminal equipment, a request for indicating to stop the first AI/ML module and/or the second AI/ML module.

According to another aspect of the embodiments of this disclosure, there is provided an indication apparatus, the apparatus includes:
a second processing unit, configured to determine a first AI/ML module in a terminal equipment and/or a second AI/ML module in a network device are/is to be stopped; and
a second transmitting unit configured to transmit to the terminal equipment a request for indicating to stop the first AI/ML module and/or the second AI/ML module.

According to another aspect of the embodiments of this disclosure, there is provided a network system, including:
a terminal equipment configured to determine a first AI/ML module in a terminal equipment and/or a second AI/ML module in a network device are/is to be stopped; and transmit to the network device a request for indicating to stop the first AI/ML module and/or the second AI/ML module; and/or
a network device configured to determine a first AI/ML module in a terminal equipment and/or a second AI/ML module in a network device are/is to be stopped; and transmit to the terminal equipment a request for indicating to stop the first AI/ML module and/or the second AI/ML module.

According to various embodiments of the present disclosure, a terminal equipment or a network device determines that a first AI/ML module in the terminal equipment and/or a second AI/ML module in a network device are/is to be stopped; and transmits a request for indicating to stop the first AI/ML module and/or the second AI/ML module. Therefore, the AI/ML modules in a terminal equipment side and a network device side are turn off synchronously.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram which shows a wireless communication network;

FIG. 2 is a diagram which shows a solution of compressed CSI over air interface;

FIG. 3 is another diagram which shows a solution of compressed CSI over air interface;

FIG. 4 is a schematic diagram which shows an indication method in accordance with an embodiment of the present disclosure;

FIG. 5 is another schematic diagram which shows an indication method in accordance with an embodiment of the present disclosure;

FIG. 6 is another schematic diagram which shows an indication method in accordance with an embodiment of the present disclosure;

FIG. 7 is another schematic diagram which shows an indication method in accordance with an embodiment of the present disclosure;

FIG. 8 is another schematic diagram which shows an indication method in accordance with an embodiment of the present disclosure;

FIG. 9 is another schematic diagram which shows an indication method in accordance with an embodiment of the present disclosure;

FIG. 10 is another schematic diagram which shows an indication method in accordance with an embodiment of the present disclosure;

FIG. 11 is another schematic diagram which shows an indication method in accordance with an embodiment of the present disclosure;

FIG. 12 is another schematic diagram which shows an indication method in accordance with an embodiment of the present disclosure;

FIG. 13 is another schematic diagram which shows an indication method in accordance with an embodiment of the present disclosure;

FIG. 14 is another schematic diagram which shows an indication method in accordance with an embodiment of the present disclosure;

FIG. 15 is another schematic diagram which shows an indication method in accordance with an embodiment of the present disclosure;

FIG. 16 is another schematic diagram which shows an indication method in accordance with an embodiment of the present disclosure;

FIG. 17 is another schematic diagram which shows an indication method in accordance with an embodiment of the present disclosure;

FIG. 18 is another schematic diagram which shows an indication method in accordance with an embodiment of the present disclosure;

FIG. 19 is another schematic diagram which shows an indication method in accordance with an embodiment of the present disclosure;

FIG. 20 is another schematic diagram which shows an indication method in accordance with an embodiment of the present disclosure;

FIG. 21 is another schematic diagram which shows an indication method in accordance with an embodiment of the present disclosure;

FIG. 22 is a schematic diagram which shows CSI report configuration in accordance with an embodiment of the present disclosure;

FIG. 23 is another schematic diagram which shows an indication method in accordance with an embodiment of the present disclosure;

FIG. 24 is another schematic diagram which shows an indication method in accordance with an embodiment of the present disclosure;

FIG. 25 is another schematic diagram which shows an indication method in accordance with an embodiment of the present disclosure;

FIG. 26 is another schematic diagram which shows an indication method in accordance with an embodiment of the present disclosure;

FIG. 27 is another schematic diagram which shows an indication method in accordance with an embodiment of the present disclosure;

FIG. 28 is another schematic diagram which shows an indication method in accordance with an embodiment of the present disclosure;

FIG. 29 is another schematic diagram which shows an indication method in accordance with an embodiment of the present disclosure;

FIG. 30 is a block diagram of an indication apparatus in accordance with an embodiment of the present disclosure;

FIG. 31 is another block diagram of an indication apparatus in accordance with an embodiment of the present disclosure;

FIG. 32 is a schematic diagram of the network device of an embodiment of this disclosure; and

FIG. 33 is a schematic diagram of the terminal equipment of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

As used herein, the term “wireless communication network” refers to a network following any suitable communication standards, such as LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable, and/or other suitable the first generation (1G), the second generation (2G), 2.5G, 2.75G, the third generation (3G), the fourth generation (4G), 4.5G, the fifth generation (5G) communication protocols, the future 6th generation (6G) communication protocols, wireless local area network (WLAN) standards, such as the IEEE 802.11 standards; and/or any other appropriate wireless communication standard, such as the Worldwide Interoperability for Microwave Access (WiMAX), Bluetooth, and/or ZigBee standards, and/or any other protocols either currently known or to be developed in the future.

The term “network device” refers to a device in a wireless communication network via which a terminal device accesses the network and receives services therefrom. The network device refers a base station (BS), an access point (AP), or any other suitable device in the wireless communication network. The BS may be, for example, a node B (NodeB or NB), an evolved NodeB (eNodeB or eNB), or gNB, a CU, a DU, a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes, a central signal processing pool or a central computing pool of a base station or several base stations. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal equipment” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, image capture terminal devices such as digital cameras, gaming terminal devices, music storage and playback appliances, a mobile phone, a cellular phone, a smart phone, voice over IP (VOIP) phones, wireless local loop phones, a tablet, a wearable device, a personal digital assistant (PDA), portable computers, desktop computer, image capture terminal devices such as digital cameras, gaming terminal devices, music storage and playback appliances, wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably.

As one example, a terminal device may represent a UE configured for communication in accordance with one or more communication standards promulgated by the 3rd Generation Partnership Project (3GPP), such as 3GPP's GSM, UMTS, LTE, and/or 5G standards, and/or 6G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication or V2X communication, for example by implementing a 3GPP standard for sidelink communication, and may in this case be referred to as a D2D communication device or V2X communication device.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink, DL transmission refers to a transmission from the network device to a terminal device, and an uplink, UL transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

Now some exemplary embodiments of the present disclosure will be described below with reference to the figures.

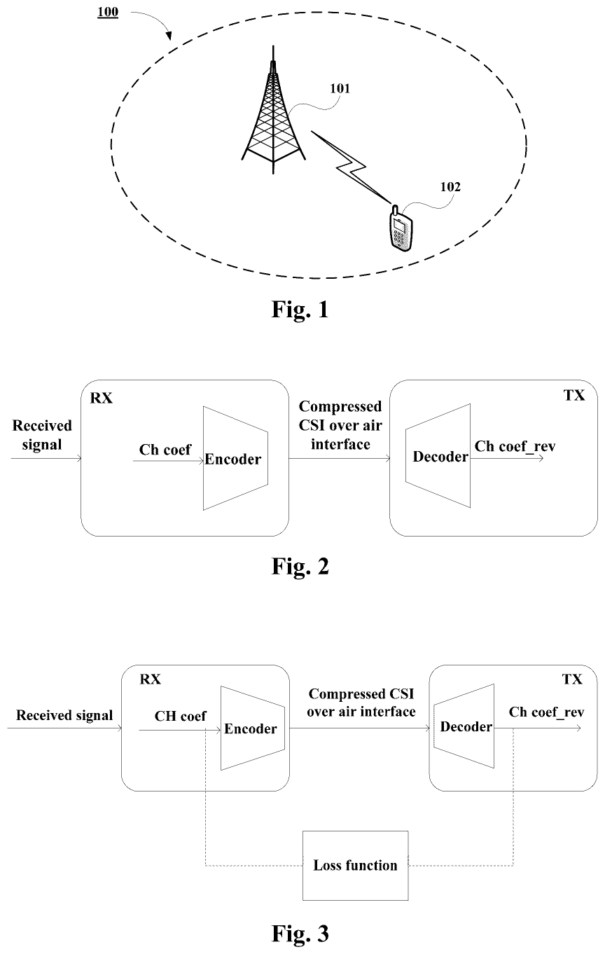

Reference is first made to FIG. 1, FIG. 1 shows a schematic diagram of a wireless communication network 100 in which embodiments of the disclosure may be implemented. As shown in FIG. 1, the wireless communication network 100 may include one or more network devices, for example network devices 101.

It will be appreciated that the network device 101 could also be in a form of gNB, CU (Centralized Unit), DU (Distributed Unit), RU (Radio Unit), IAB Donor, IAB Node, Relay, repeater, network-controlled repeaters, Node B, eNB, BTS (Base Transceiver Station), and/or BSS (Base Station Subsystem), access point (AP) and the like. The network device 101 may provide radio connectivity to a set of terminal devices or UEs 102-1, 102-2, . . . , 102-N (collectively referred to as “terminal device(s) 102) within its coverage, where N is a natural number.

The network device 101 includes processing circuitry, device readable medium, interface, user interface equipment, auxiliary equipment, power source, power delivery circuitry, and antenna. These components are depicted as single boxes located within a single larger box, and in some cases, contain additional boxes therein.

In practice, however, the network device 101 may include multiple different physical components that make up a single illustrated component (e.g., interface includes ports/terminals for coupling wires for a wired connection and radio front end circuitry for a wireless connection). As another example, the network device 101 may be a virtual network node. Similarly, a network node may be composed of multiple physically separate components (e.g., a NodeB component and an RNC component, a BTS component and a BSC component, etc.), which may each have their own respective components.

In certain scenarios in which the network device 101 includes multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, a network node may be configured to support multiple radio access technologies (RATs). In such embodiments, some components may be duplicated (e.g., separate device readable medium for the different RATs) and some components may be reused (e.g., the same antenna may be shared by the RATs).

Although the network device 101 illustrated in the example wireless communication network may represent a device that includes a particular combination of hardware components, other embodiments may include network nodes with different combinations of components. It is to be understood that a network device may include any suitable combination of hardware and/or software needed to perform the tasks, features, functions and methods disclosed herein.

It is to be understood that the configuration of FIG. 1 is described merely for the purpose of illustration, without suggesting any limitation as to the scope of the present disclosure. Those skilled in the art would appreciate that the wireless communication network 100 may include any suitable number of terminal devices and/or network devices and may have other suitable configurations.

In massive MIMO systems, such as 5G NR systems, and 6G systems, reducing feedback overhead for CSI (channel state information) is important for increasing throughput. Using AI/ML to reduce CSI overhead has significant gain over related method.

FIG. 2 is a diagram which shows a solution of compressed CSI over air interface. As shown in FIG. 2, by using so called encoder/decoder in deep learning field, a CSI compressing method is proposed.

As shown in FIG. 2, a received signal in a RX side is used to estimate channel coefficients (Ch coef). The estimated channel coefficients are fed into an AI encoder. In the encoder, the input signal is compressed to a vector with a smaller size of the input signal by a neural network. The compressed vector is feedback to a TX side over the air interface. The decoder (with function of using neural network to de-compress its input signal) at the TX side is used to recover the compressed vector to its original dimension. It is expected the recovered channel coefficients (Ch coef_rev) of the decoder at the TX side is approached to the channel coefficients of the encoder at the RX side.

One interesting point for the AI encoder and the AI decoder is that two neural networks should be trained together. The AI encoder works well with the AI decoder trained together when deploying them in a practical network. Such kind of neural network is called as an AI/ML paired neural network in this disclosure.

FIG. 3 is another diagram which shows a solution of compressed CSI over air interface. In a training procedure, a neural network as the encoder and a neural network as the decoder are trained together, targeting to minimize a loss function. Through the training procedure and following testing procedure as well as validation procedure to optimize network structure and parameters, the encoder and the decoder are used together to keep similar performance as what they can provided as the loss function.

The well-trained encoder and decoder are deployed at the RX side and the TX side respectively. Besides CSI compression/de-compression, an AI/ML paired neural network can be utilized in other signal processing function pairs in a communication link. For example, modulation and demodulation can be realized by an AI/ML paired neural network.

To easy explanation in this disclosure, AIpNN is used as a short name for an AI/ML paired neural network, AItxNN is used as the short name for the neural network of the TX side, and AIrxNN is used as the short name for the neural network of the RX side. For example, AI encoder includes an AItxNN, and AI decoder includes an AIrxNN.

In the following description, a first AI/ML and/or a second AI/ML are/is used, the first AI/ML and the second AI/ML may include a paired neural network. For example, the first AI/ML includes AItxNN and the second AI/ML includes AIrxNN, or, the first AI/ML includes AIrxNN and the second AI/ML includes AItxNN, and it is not limited thereto.

### First Aspect of Embodiments

In mobile communication system, a terminal equipment may move and work in different places and will experience a kind of scenarios, such as indoor, outdoor, urban area, rural area etc. The AI neural network in a terminal equipment may not always work well. It is also true for the neural network resided in a network device, since network devices are deployed in different area with different environments.

Another practical challenge comes from computation capability for supporting AI/ML processing. There may be certain restrictions to support multiple AI/ML functions at the same time. In order to support peak data rate, a computing unit may be used to perform high layer MIMO processing, while lack of computing unit to support AI/ML processing.

For real time sensitive use cases, it is also not sure whether the neural network is able to always meet latency requirement with a certain performance request. Besides, from power consumption perspective, high power consuming from running AI/ML will be a problematic if AI/ML is used in a terminal equipment side. From a request of green communication, potential power increasing from widely applying AI/ML technique to a network device side also should be considered beforehand.

The inventors found that such kind of gains and pains from applications of AI/ML technique into 5G NR and 6G wireless systems, bring a request on how to intelligent synchronize the operations of AI/ML module(s) in a terminal equipment side and AI/ML module(s) in a network device side, in order to avoid performance degradation, reduce power consumption, relax computing power, and so on and so forth. For example, if the AItxNN is stopped, the AIrxNN should be stopped as well. For the same reason, they should be run together.

An indication method is provided in the disclosure. In some embodiments, an AI/ML stop indication is initiated by a terminal equipment.

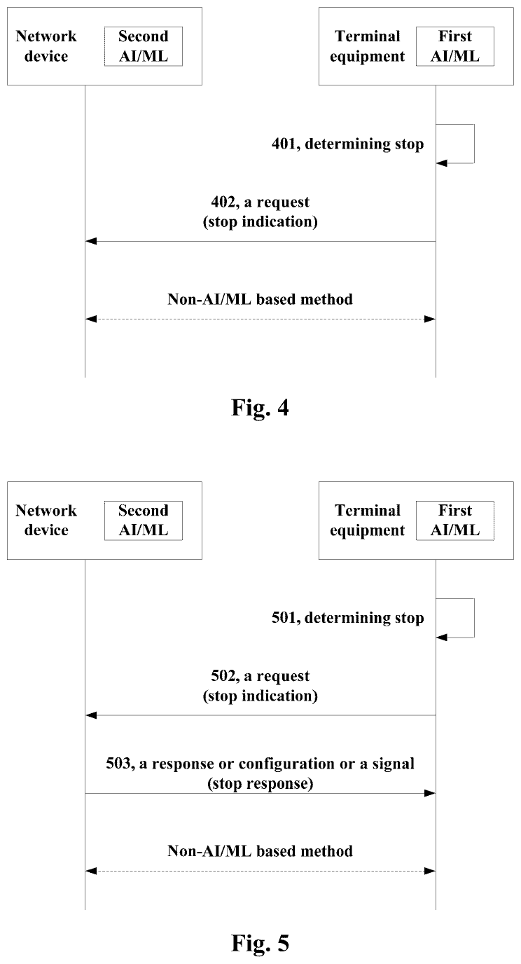

FIG. 4 is a schematic diagram which shows an indication method in accordance with an embodiment of the present disclosure, and illustrates the indication method as an example.

As shown in FIG. 4, the method includes:
401, a terminal equipment determines that a first AI/ML module in the terminal equipment and/or a second AI/ML module in a network device are/is to be stopped; and
402, the terminal equipment transmits a request for indicating to stop the first AI/ML module and/or the second AI/ML module.

It should be appreciated that FIG. 4 is only an example of the disclosure, it is not limited thereto. For example, the order of operations or steps may be adjusted and/or some operations or steps may be omitted. Moreover, some operations or steps not shown in FIG. 4 may be added.

Therefore, the terminal equipment side initiates the stop procedure. For example, the terminal equipment detects the AIpNN for a certain communication function need to be stopped, and sends an AI/ML stop request to the network device side. Upon receiving the stop request, the network device will stop its second AI/ML in the next signal processing according to its function. Both the network device and the terminal device will switch to use non-AI based method in the following signal processing for the same function of the AI based method.

For example, the terminal equipment detects the AIpNN cannot run well, or there is no enough power for running AI/ML, or its computation capability cannot support running AItxNN, or other factors let the terminal equipment decides to stop AItxNN. The terminal equipment may stop its AItxNN first, and transmit an AI/ML stop indication to the network device after there is an uplink resource for the terminal equipment to send the indication. In this case, upon receiving the AI/ML stop indication, the network device stops its AIrxNN directly.

FIG. 5 is another schematic diagram which shows an indication method in accordance with an embodiment of the present disclosure, and illustrates the indication method as an example.

As shown in FIG. 5, the method includes:
501, a terminal equipment determines that a first AI/ML module in the terminal equipment and/or a second AI/ML module in a network device are/is to be stopped;
502, the terminal equipment transmits a request for indicating to stop the first AI/ML module and/or the second AI/ML module; and
503, the terminal equipment receives a response or a configuration or a signal for indicating that the first AI/ML module and/or the second AI/ML module are/is to be stopped.

It should be appreciated that FIG. 5 is only an example of the disclosure, it is not limited thereto. For example, the order of operations or steps may be adjusted and/or some operations or steps may be omitted. Moreover, some operations or steps not shown in FIG. 5 may be added.

For example, in order to guarantee performance, the terminal equipment side cannot stop its AI/ML by itself without an approval from the network device side. The terminal equipment sends an AI/ML stop request first. Upon receiving the request, the network device send an AI/ML stop response to the terminal equipment. The network device stops its AI/ML after sending the AI/ML stop response, and the terminal equipment stops its AI/ML after receiving the response. The network device and the terminal equipment will switch to non-AI/ML based method in the next signal processing for the same function of the AI based method.

For another example, the terminal equipment may receive configuration for indicating that the first AI/ML module and/or the second AI/ML module are/is to be stopped; wherein AI/ML module is disabled in the configuration or there is not AI/ML related information in the configuration, or is deactivated via media access control (MAC) control element (CE) or downlink control information (DCI).

In some embodiments, the request is transmitted via physical uplink control channel (PUCCH), and/or, the request is transmitted via physical uplink shared channel (PUSCH), and it is not limited.

In some embodiments, the request is transmitted via physical uplink control channel (PUCCH), and confirmation of receiving the PUCCH is the configuration without AI/ML parameter.

In some embodiments, the request is transmitted via physical uplink shared channel (PUSCH) and the response is an acknowledge (ACK) of the PUSCH; and it is not limited thereto.

In some embodiments, in order to synchronize the stop operation, the network device may send an AI stop timing to the terminal equipment.

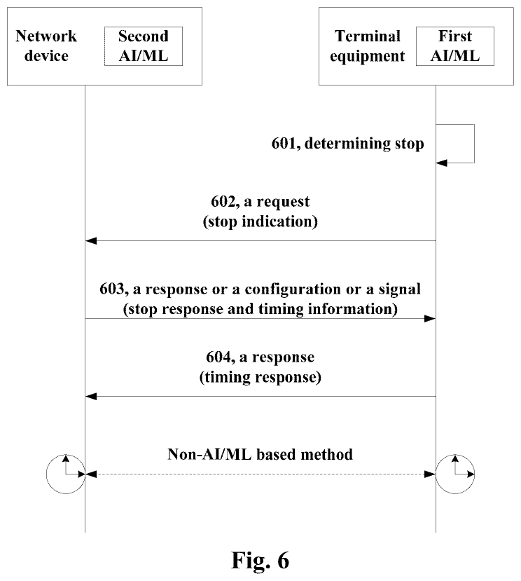

FIG. 6 is another schematic diagram which shows an indication method in accordance with an embodiment of the present disclosure, and illustrates the indication method as an example.

As shown in FIG. 6, the method includes:
601, a terminal equipment determines that a first AI/ML module in the terminal equipment and/or a second AI/ML module in a network device are/is to be stopped;
602, the terminal equipment transmits a request for indicating to stop the first AI/ML module and/or the second AI/ML module; and
603, the terminal equipment receives a response or a configuration or a signal for indicating that the first AI/ML module and/or the second AI/ML module are/is to be stopped.

As shown in FIG. 6, the terminal equipment may receive timing information for stopping the first AI/ML module and/or the second AI/ML module. The timing information may be transmitted together with the response, and it is not limited. For example, the timing information may be transmitted respectively by another message. The timing information can also be indicated by MAC CE or DCI to de-activate the operations realized by the first AI/ML module and/or the second AI/ML module.

As shown in FIG. 6, in some embodiments, the method further includes:
604, the terminal equipment transmits a response of the timing information.

It should be appreciated that FIG. 6 is only an example of the disclosure, it is not limited thereto. For example, the order of operations or steps may be adjusted and/or some operations or steps may be omitted. Moreover, some operations or steps not shown in FIG. 6 may be added.

For example, upon receiving stop timing information, the terminal equipment may feedback ACK or send a message to the network device for ensuring the timing. With the stop timing, the network device stops its AIrxNN and the terminal equipment stops its AItxNN, and the network device and the terminal equipment switch to use non-AI/ML based method for following relevant processing.

In some embodiments, the timing information is transmitted via control information and/or data information; the control information includes at least one of main information block (MIB), system information block (SIB), or downlink control information (DCI), and it is not limited thereto.

In some embodiments, the timing information is configured via radio resource control message and is activated via media access control (MAC) control element (CE) or downlink control information (DCI).

In some embodiments, the timing information is implicitly indicated via RRC (re) configuration, and/or MAC CE (de) activation, and/or DCI (de) activation. The terminal equipment may transmit a response of indication of the timing information.

In some embodiments, the timing information is transmitted via physical downlink shared channel (PDSCH) and the response of the timing information is an acknowledge (ACK) of the PDSCH.

In some embodiments, the timing information includes stopping time and/or step time of the first AI/ML module and/or the second AI/ML module.

For example, the timing information includes stopping time, the terminal equipment and the network device will stop the AI/ML at the stopping time (such as an SFN). For another example, the timing information includes step time (such as a slot offset or a period), the terminal equipment will stop the AI/ML after the step time upon receiving the response, the network device will stop the AI/ML after the step time from transmitting the response.

In some embodiments, the terminal equipment determines the first AI/ML module and/or the second AI/ML module are/is to be stopped according to one or more signals from the network device and/or one or more parameters of the terminal equipment.

In some embodiments, the terminal equipment stops the first AI/ML module in the terminal equipment; wherein the first AI/ML module in the terminal equipment and the second AI/ML module in the network device are stopped synchronously. For example, for a certain function, the AIrxNN and the AItxNN are stopped together.

As can be seen from the above embodiments, a terminal equipment determines that a first AI/ML module in the terminal equipment and/or a second AI/ML module in a network device are/is to be stopped; and the terminal equipment transmits a request for indicating to stop the first AI/ML module and/or the second AI/ML module. Therefore, the AI/ML modules in a terminal equipment side and a network device side are turn off synchronously.

### Second Aspect of Embodiments

An indication method is provided in this disclosure. In some embodiments, an AI/ML stop indication is initiated by a network device, and the same contents as those in the first aspect of embodiments are omitted.

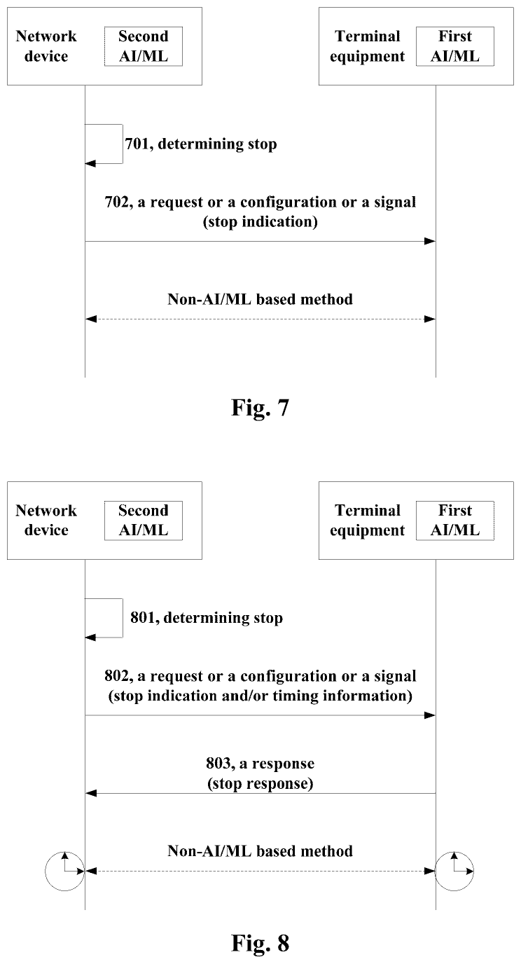

FIG. 7 is another schematic diagram which shows an indication method in accordance with an embodiment of the present disclosure, and illustrates the indication method as an example.

As shown in FIG. 7, the method includes:
701, a network device determines that a first AI/ML module in a terminal equipment and/or a second AI/ML module in the network device are/is to be stopped;
702, the network device transmits a request or a configuration or a signal for indicating to stop the first AI/ML module and/or the second AI/ML module.

It should be appreciated that FIG. 7 is only an example of the disclosure, it is not limited thereto. For example, the order of operations or steps may be adjusted and/or some operations or steps may be omitted. Moreover, some operations or steps not shown in FIG. 7 may be added.

For example, the network device may detect AIpNN performance is bad and decide to stop it, or the network device have no enough computation power to support running its AI/ML network, or the network device want to save power and stop its AI/ML network. To synchronize the operation of AIpNN, the network device transmits an AI/ML stop indication.

In some embodiments, the network device may stop the neural network of its side first, and send the AI/ML stop indication to the terminal equipment, once upon receiving the indication, the terminal equipment stops the neural network of its side as well.

For another example, the network device may transmit a configuration or a reconfiguration for indicating that the first AI/ML module and/or the second AI/ML module are/is to be stopped; wherein AI/ML module is disabled in the configuration or the reconfiguration, or there is not AI/ML related information in the configuration or the reconfiguration, or is deactivated via media access control (MAC) control element (CE) or downlink control information (DCI).

FIG. 8 is another schematic diagram which shows an indication method in accordance with an embodiment of the present disclosure, and illustrates the indication method as an example.

As shown in FIG. 8, the method includes:
801, a network device determines that a first AI/ML module in a terminal equipment and/or a second AI/ML module in the network device are/is to be stopped;
802, the network device transmits a request or a configuration or a signal for indicating to stop the first AI/ML module and/or the second AI/ML module; and
803, the network device receives a response for indicating that the first AI/ML module and/or the second AI/ML module are/is to be stopped.

As shown in FIG. 8, the network device may transmit timing information for stopping the first AI/ML module and/or the second AI/ML module. The timing information may be transmitted together with the request, and it is not limited. For example, the timing information may be transmitted respectively by another message.

It should be appreciated that FIG. 8 is only an example of the disclosure, it is not limited thereto. For example, the order of operations or steps may be adjusted and/or some operations or steps may be omitted. Moreover, some operations or steps not shown in FIG. 8 may be added.

In some embodiments, the request is transmitted via physical downlink control channel (PDCCH) and/or physical downlink shared channel (PDSCH), and it is not limited thereto.

In some embodiments, the request is transmitted via physical downlink shared channel (PDSCH) and the response is an acknowledge (ACK) of the PDSCH, and it is not limited thereto.

In some embodiments, the timing information is transmitted via control information and/or data information; the control information comprises at least one of main information block (MIB), system information block (SIB), or downlink control information (DCI), and it is not limited thereto.

In some embodiments, the timing information is configured via radio resource control message and is activated via media access control (MAC) control element (CE) or downlink control information (DCI), and it is not limited thereto.

In some embodiments, the timing information is implicitly indicated via RRC (re) configuration, or MAC CE (de) activation, or DCI (de) activation. The terminal equipment may transmit a response of indication of the timing information.

In some embodiments, the timing information includes stopping time and/or step time of the first AI/ML module and/or the second AI/ML module.

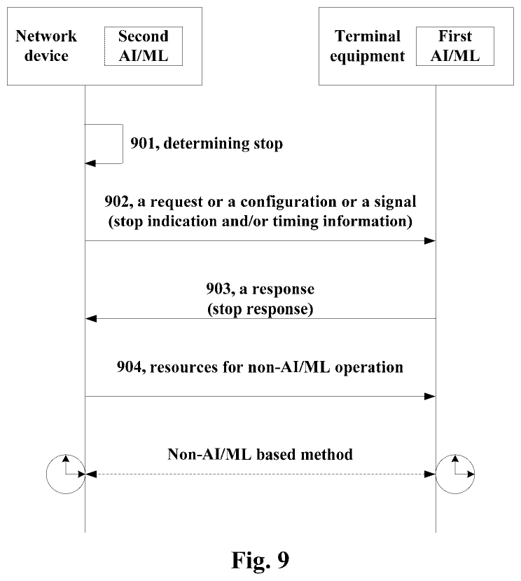

FIG. 9 is another schematic diagram which shows an indication method in accordance with an embodiment of the present disclosure, and illustrates the indication method as an example. As shown in FIG. 9, the method includes:
901, a network device determines that a first AI/ML module in a terminal equipment and/or a second AI/ML module in the network device are/is to be stopped;
902, the network device transmits a request or a configuration or a signal for indicating to stop the first AI/ML module and/or the second AI/ML module; and
903, the network device receives a response for indicating that the first AI/ML module and/or the second AI/ML module are/is to be stopped.

As shown in FIG. 9, the network device may transmit timing information for stopping the first AI/ML module and/or the second AI/ML module. The timing information may be transmitted together with the request, and it is not limited. For example, the timing information may be transmitted respectively by another message.

As shown in FIG. 9, the method further includes:
904, the network device transmits one or more resources for non-AI/ML operation. For example, the resources for non-AI/ML operation are configured or reconfigured via RRC, and/or activated via MAC CE, and/or activated via DCI.

It should be appreciated that FIG. 9 is only an example of the disclosure, it is not limited thereto. For example, the order of operations or steps may be adjusted and/or some operations or steps may be omitted. Moreover, some operations or steps not shown in FIG. 9 may be added.

For example, upon receiving the stop indication and the stop timing, the terminal equipment may feedback a message as the AI stop response, or confirm the stop indication via ACK. Based on the stop timing, the terminal equipment stops its AItxNN and switches to non-AI based operation for its following relevant processing. The network device also stops its AIrxNN and switches non-AI based operation for its following relevant processing.

In some embodiments, the network device determines the first AI/ML module and/or the second AI/ML module are/is to be stopped according to one or more signals from the terminal equipment and/or one or more parameters of the network device.

In some embodiments, the network device stops the second AI/ML module in the network device; wherein the first AI/ML module in the terminal equipment and the second AI/ML module in the network device are stopped synchronously. For example, the AIrxNN and the AItxNN are stopped together.

As can be seen from the above embodiments, a network device determines that a first AI/ML module in a terminal equipment and/or a second AI/ML module in the network device are/is to be stopped; and the network device transmits a request for indicating to stop the first AI/ML module and/or the second AI/ML module. Therefore, the AI/ML modules in terminal equipment side and network device side are turn off synchronously.

### Third Aspect of Embodiments

An indication method is provided in this disclosure. In some embodiments, an AI/ML start indication (or called run indication) is initiated by a terminal equipment, and the third aspect of embodiments can be combined with the first and/or aspects of the embodiments; the same contents as those in the first and/or aspects of embodiments are omitted.

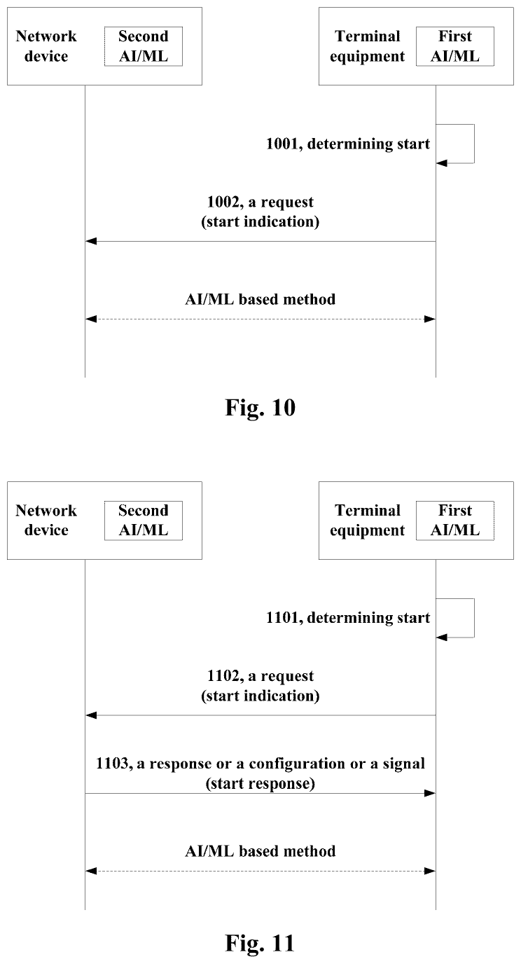

FIG. 10 is another schematic diagram which shows an indication method in accordance with an embodiment of the present disclosure, and illustrates the indication method as an example. As shown in FIG. 10, the method includes:
1001, a terminal equipment determines that a first AI/ML module in the terminal equipment and/or a second AI/ML module in a network device are/is to be started; and
1002, the terminal equipment transmits a request for indicating to start the first AI/ML module and/or the second AI/ML module.

It should be appreciated that FIG. 10 is only an example of the disclosure, it is not limited thereto. For example, the order of operations or steps may be adjusted and/or some operations or steps may be omitted. Moreover, some operations or steps not shown in FIG. 10 may be added.

Therefore, the terminal equipment side initiates the start procedure. For example, the terminal equipment detects the AIpNN for a certain communication function need to be started, and sends an AI/ML start request to the network device side.

For example, the terminal equipment detects the AIpNN need to run. The terminal equipment may start its AItxNN first, and transmit an AI/ML start indication to the network device after there is an uplink resource for the terminal equipment to send the indication. In this case, upon receiving the AI/ML start indication, the network device starts its AIrxNN directly.

For example, the terminal equipment with the AI/ML capability may initiate the AI-based operation, while the terminal equipment without the AI/ML capability cannot do it. If the network device has the AI/ML capability as well, the following shake hands operation for the AI-based method will be done subsequently, which are omitted here.

FIG. 11 is another schematic diagram which shows an indication method in accordance with an embodiment of the present disclosure, and illustrates the indication method as an example. As shown in FIG. 11, the method includes:
1101, a terminal equipment determines that a first AI/ML module in the terminal equipment and/or a second AI/ML module in a network device are/is to be started;
1102, the terminal equipment transmits a request for indicating to start the first AI/ML module and/or the second AI/ML module; and
1103, the terminal equipment receives a response or a configuration or a signal for indicating that the first AI/ML module and/or the second AI/ML module are/is to be started; wherein AI/ML module is enabled in the configuration or there is AI/ML related information in the configuration, or is activated via media access control (MAC) control element (CE) or downlink control information (DCI).

It should be appreciated that FIG. 11 is only an example of the disclosure, it is not limited thereto. For example, the order of operations or steps may be adjusted and/or some operations or steps may be omitted. Moreover, some operations or steps not shown in FIG. 11 may be added.

For example, in order to guarantee performance, the terminal equipment side cannot start its AI/ML by itself without an approval from the network device side. The terminal equipment sends an AI/ML start request first. Upon receiving the request, the network device send an AI/ML start response to the terminal equipment. The network device starts its AI/ML after sending the AI/ML start response, and the terminal equipment starts its AI/ML after receiving the response.

In some embodiments, the request is transmitted via physical uplink control channel (PUCCH), and/or, the request is transmitted via physical uplink shared channel (PUSCH), and it is not limited.

In some embodiments, the request is transmitted via physical uplink shared channel (PUSCH) and the response is an acknowledge (ACK) of the PUSCH; and it is not limited thereto.

In some embodiments, in order to synchronize the start operation, the network device may send an AI/ML start timing to the terminal equipment.

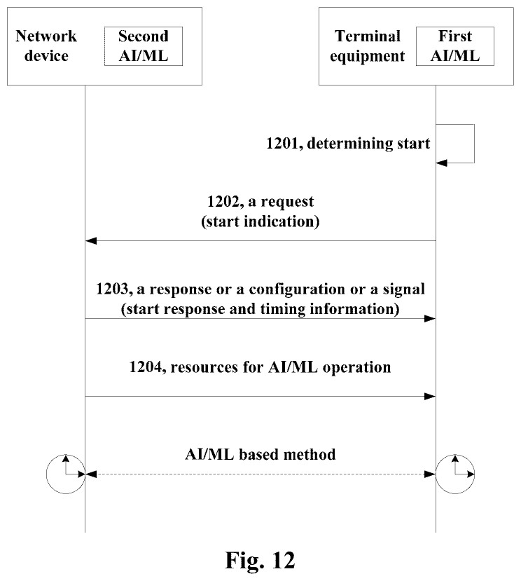

FIG. 12 is another schematic diagram which shows an indication method in accordance with an embodiment of the present disclosure, and illustrates the indication method as an example.

As shown in FIG. 12, the method includes:
1201, a terminal equipment determines that a first AI/ML module in the terminal equipment and/or a second AI/ML module in a network device are/is to be started;
1202, the terminal equipment transmits a request for indicating to start the first AI/ML module and/or the second AI/ML module; and
1203, the terminal equipment receives a response or a configuration or a signal for indicating that the first AI/ML module and/or the second AI/ML module are/is to be started.

As shown in FIG. 12, the terminal equipment may receive timing information for starting the first AI/ML module and/or the second AI/ML module. The timing information may be transmitted together with the response, and it is not limited. For example, the timing information may be transmitted respectively by another message.

As shown in FIG. 12, in some embodiments, the method further includes:
1204, the network device transmits one or more resources for AI/ML operation. For example, the resources for AI/ML operation are configured or reconfigured via RRC, and/or activated via MAC CE, and/or scheduled via DCI.

It should be appreciated that FIG. 12 is only an example of the disclosure, it is not limited thereto. For example, the order of operations or steps may be adjusted and/or some operations or steps may be omitted. Moreover, some operations or steps not shown in FIG. 12 may be added.

For example, upon receiving start timing information, the terminal equipment may feedback ACK or send a message to the network device for ensuring the timing. With the start timing, the network device starts its AIrxNN and the terminal equipment starts its AItxNN, and the network device and the terminal equipment switch to use AI/ML based method for following relevant processing.

In some embodiments, the timing information is transmitted via control information and/or data information; the control information includes at least one of main information block (MIB), system information block (SIB), or downlink control information (DCI), and it is not limited thereto.

In some embodiments, the timing information is configured via radio resource control message and is activated via media access control (MAC) control element (CE) or downlink control information (DCI).

In some embodiments, the timing information is transmitted via physical downlink shared channel (PDSCH) and the response of the timing information is an acknowledge (ACK) of the PDSCH.

In some embodiments, the timing information includes starting time and/or step time of the first AI/ML module and/or the second AI/ML module.

For example, the timing information includes starting time, the terminal equipment and the network device will start the AI/ML at the starting time. For another example, the timing information includes step time, the terminal equipment will start the AI/ML after the step time upon receiving the response, the network device will start the AI/ML after the step time from transmitting the response.

In some embodiments, the terminal equipment determines the first AI/ML module and/or the second AI/ML module are/is to be started according to one or more signals from the network device and/or one or more parameters of the terminal equipment.

In some embodiments, the terminal equipment starts the first AI/ML module in the terminal equipment; wherein the first AI/ML module in the terminal equipment and the second AI/ML module in the network device are started synchronously. For example, the AIrxNN and the AItxNN are started together.

In some embodiments, the start operations descripted in the third aspect of embodiments are performed after the stop operations descripted in the first and/or aspects of embodiments. For example, the methods in any one of FIGS. 10-12 are executed after the methods in any one of FIGS. 4-9. In those cases, the start operations may be called run operations or recovery operations.

As can be seen from the above embodiments, a terminal equipment determines that a first AI/ML module in the terminal equipment and/or a second AI/ML module in a network device are/is to be started; and the terminal equipment transmits a request for indicating to start the first AI/ML module and/or the second AI/ML module. Therefore, the AI/ML modules in a terminal equipment side and a network device side are turn on synchronously.

### Fourth Aspect of Embodiments

An indication method is provided in this disclosure. In some embodiments, an AI/ML start indication (or called run indication) is initiated by a network device, and the fourth aspect of embodiments can be combined with the first and/or aspects of the embodiments; the same contents as those in the first and/or aspects of embodiments are omitted.

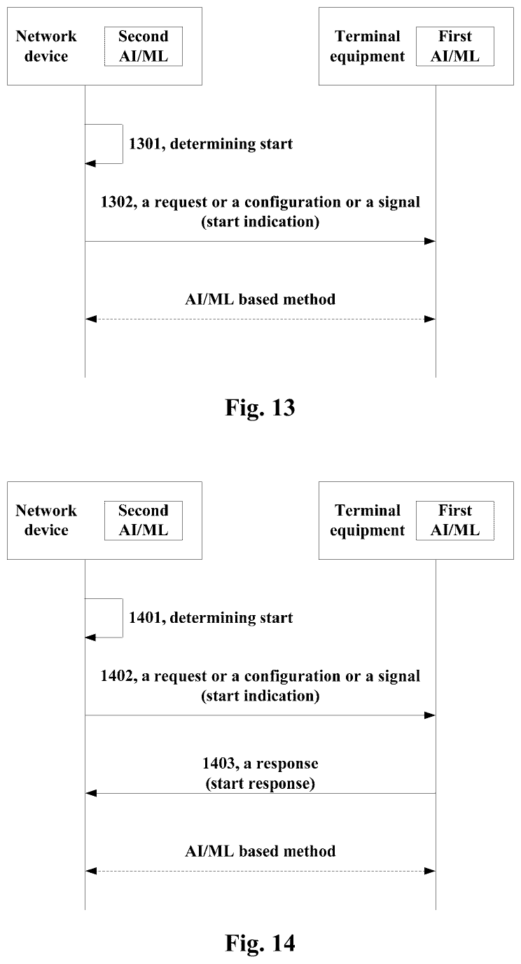

FIG. 13 is another schematic diagram which shows an indication method in accordance with an embodiment of the present disclosure, and illustrates the indication method as an example.

As shown in FIG. 13, the method includes:
1301, a network device determines that a first AI/ML module in a terminal equipment and/or a second AI/ML module in the network device are/is to be started;
1302, the network device transmits a request or a configuration or a signal for indicating to start the first AI/ML module and/or the second AI/ML module; wherein AI/ML module is enabled in the configuration or there is AI/ML related information in the configuration, or is activated via media access control (MAC) control element (CE) or downlink control information (DCI).

It should be appreciated that FIG. 13 is only an example of the disclosure, it is not limited thereto. For example, the order of operations or steps may be adjusted and/or some operations or steps may be omitted. Moreover, some operations or steps not shown in FIG. 13 may be added.

For example, the network device may detect AIpNN need to run. To synchronize the operation of AIpNN, the network device transmits an AI/ML start indication.

In some embodiments, the network device may start the neural network of its side first, and send the AI/ML start indication to the terminal equipment, once upon receiving the indication, the terminal equipment starts the neural network of its side as well.

FIG. 14 is another schematic diagram which shows an indication method in accordance with an embodiment of the present disclosure, and illustrates the indication method as an example.

As shown in FIG. 14, the method includes:
1401, a network device determines that a first AI/ML module in a terminal equipment and/or a second AI/ML module in the network device are/is to be started;
1402, the network device transmits a request or a configuration or a signal for indicating to start the first AI/ML module and/or the second AI/ML module; and
1403, the network device receives a response for indicating that the first AI/ML module and/or the second AI/ML module are/is to be started.

It should be appreciated that FIG. 14 is only an example of the disclosure, it is not limited thereto. For example, the order of operations or steps may be adjusted and/or some operations or steps may be omitted. Moreover, some operations or steps not shown in FIG. 14 may be added.

In some embodiments, the request is transmitted via physical downlink control channel (PDCCH) and/or physical downlink shared channel (PDSCH), and it is not limited thereto.

In some embodiments, the request is transmitted via physical downlink shared channel (PDSCH) and the response is an acknowledge (ACK) of the PDSCH, and it is not limited thereto.

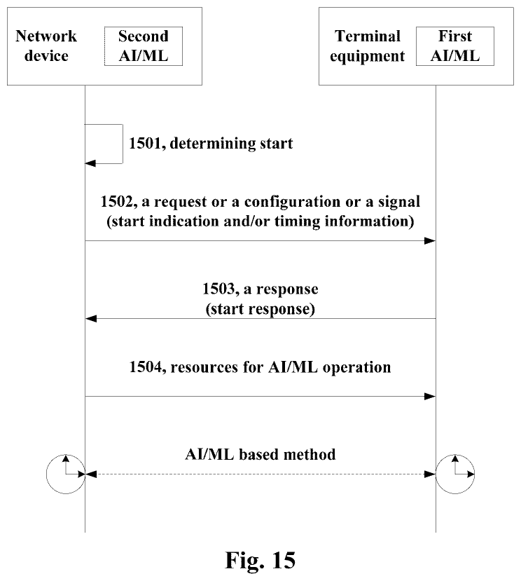

FIG. 15 is another schematic diagram which shows an indication method in accordance with an embodiment of the present disclosure, and illustrates the indication method as an example.

As shown in FIG. 15, the method includes:
1501, a network device determines that a first AI/ML module in a terminal equipment and/or a second AI/ML module in the network device are/is to be started;
1502, the network device transmits a request or a configuration or a signal for indicating to start the first AI/ML module and/or the second AI/ML module; and
1503, the network device receives a response for indicating that the first AI/ML module and/or the second AI/ML module are/is to be started.

As shown in FIG. 15, the network device may transmit timing information for stopping the first AI/ML module and/or the second AI/ML module. The timing information may be transmitted together with the request, and it is not limited. For example, the timing information may be transmitted respectively by another message.

As shown in FIG. 15, in some embodiments, the method further includes:
1504, the network device transmits one or more resources for AI/ML operation. For example, the resources for AI/ML operation are configured or reconfigured via RRC, and/or activated via MAC CE, and/or scheduled via DCI.

It should be appreciated that FIG. 15 is only an example of the disclosure, it is not limited thereto. For example, the order of operations or steps may be adjusted and/or some operations or steps may be omitted. Moreover, some operations or steps not shown in FIG. 15 may be added.

For example, upon receiving the start indication and the start timing, the terminal equipment may feedback a message as the AI start response, or confirm the start indication via ACK. Based on the start timing, the terminal equipment starts its AItxNN and switches to AI/ML based operation for its following relevant processing. The network device also starts its AIrxNN and switches to AI/ML based operation for its following relevant processing.

In some embodiments, the timing information is transmitted via control information and/or data information; the control information comprises at least one of main information block (MIB), system information block (SIB), or downlink control information (DCI), and it is not limited thereto.

In some embodiments, the timing information is configured via radio resource control message and is activated via media access control (MAC) control element (CE) or downlink control information (DCI), and it is not limited thereto.

In some embodiments, the timing information includes starting time and/or step time of the first AI/ML module and/or the second AI/ML module.

In some embodiments, the network device determines the first AI/ML module and/or the second AI/ML module are/is to be started according to one or more signals from the terminal equipment and/or one or more parameters of the network device.

In some embodiments, the network device starts the second AI/ML module in the network device; wherein the first AI/ML module in the terminal equipment and the second AI/ML module in the network device are started synchronously. For example, the AIrxNN and the AItxNN are started together.

In some embodiments, the start operations descripted in the fourth aspect of embodiments are performed after the stop operations descripted in the first and/or aspects of embodiments. For example, the methods in any one of FIGS. 13-15 are executed after the methods in any one of FIGS. 4-9. In those cases, the start operations may be called run operations or recovery operations.

As can be seen from the above embodiments, a network device determines that a first AI/ML module in a terminal equipment and/or a second AI/ML module in the network device are/is to be started; and the network device transmits a request for indicating to start the first AI/ML module and/or the second AI/ML module. Therefore, the AI/ML modules in terminal equipment side and network device side are turn on synchronously.

### Fifth Aspect of Embodiments

Based on the first to fourth aspects of embodiments, an indication method of stopping CSI encoder/decoder is provided as an example. The same contents as those in the first to fourth aspects of embodiments are omitted.

In some embodiments, the first AI/ML module and/or the second AI/ML module are/is used for channel state information (CSI) measurement; the terminal equipment includes an AI encoder and the network device includes an AI decoder.

In some embodiments, an AI/ML stop indication is initiated by a network device.

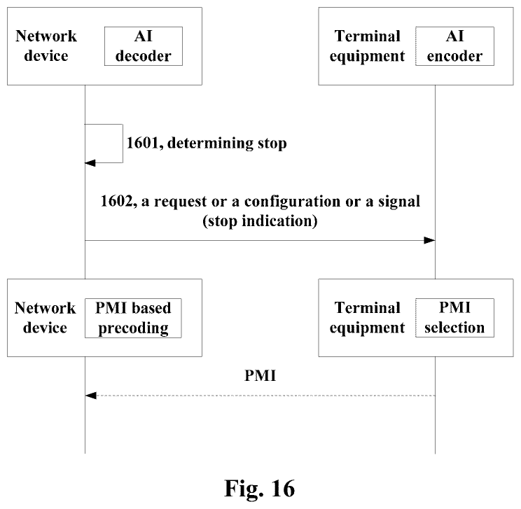

FIG. 16 is another schematic diagram which shows an indication method in accordance with an embodiment of the present disclosure, and illustrates the indication method as an example.

As shown in FIG. 16, the method includes:
1601, a network device determines that an AI encoder in a terminal equipment and/or an AI decoder in the network device are/is to be stopped;
1602, the network device transmits a request or a configuration or a signal for indicating to stop the AI encoder and/or the AI decoder.

It should be appreciated that FIG. 16 is only an example of the disclosure, it is not limited thereto. For example, the order of operations or steps may be adjusted and/or some operations or steps may be omitted. Moreover, some operations or steps not shown in FIG. 16 may be added.

For example, the network device may detect AIpNN performance is bad and decide to stop it, or the network device have no enough computation power to support running its AI/ML network, or the network device want to save power and stop its AI/ML network. To synchronize the operation of AIpNN, the network device transmits an AI/ML stop indication.

As shown in FIG. 16, the network device switches from AI/ML based CSI decoding into precoding matrix indicator (PMI) based precoding. The terminal equipment switches from AI/ML based CSI encoding to precoding matrix indicator (PMI) selection (codebook-based method, NR codebook type 1, type 2, etype 2 or other type of codebook, e.g.).

In some embodiments, the network device may stop the neural network of its side first, and send the AI/ML stop indication to the terminal equipment, once upon receiving the indication, the terminal equipment stops the neural network of its side as well.

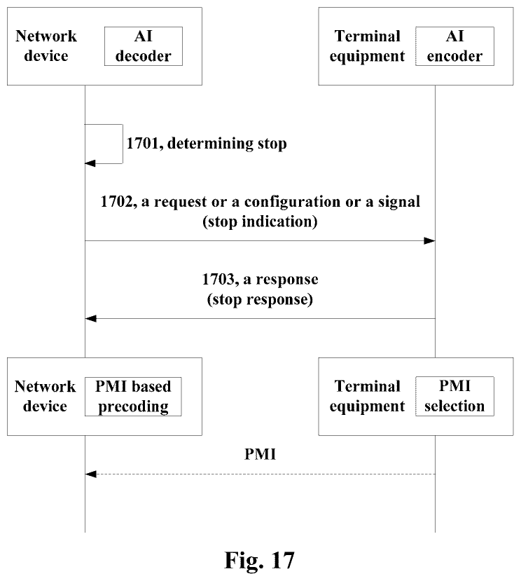

FIG. 17 is another schematic diagram which shows an indication method in accordance with an embodiment of the present disclosure, and illustrates the indication method as an example.

As shown in FIG. 17, the method includes:
1701, a network device determines that an AI encoder in a terminal equipment and/or an AI decoder in the network device are/is to be stopped;
1702, the network device transmits a request or a configuration, or a signal for indicating to stop the AI encoder and/or the AI decoder; and
1703, the network device receives a response for indicating that the AI encoder and/or the AI decoder are/is to be stopped.

It should be appreciated that FIG. 17 is only an example of the disclosure, it is not limited thereto. For example, the order of operations or steps may be adjusted and/or some operations or steps may be omitted. Moreover, some operations or steps not shown in FIG. 17 may be added.

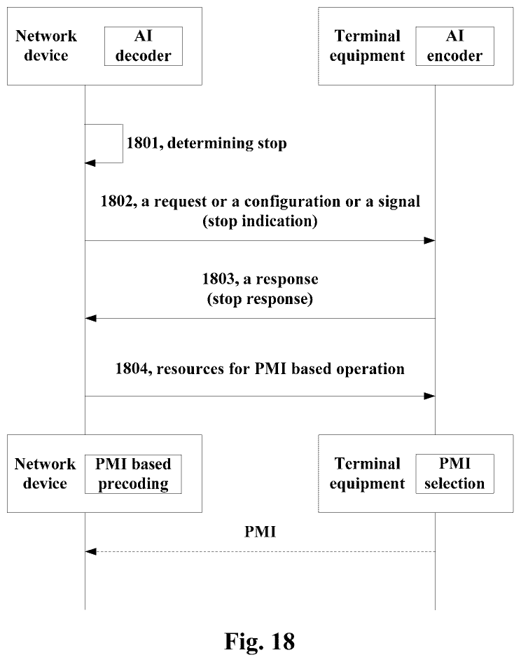

FIG. 18 is another schematic diagram which shows an indication method in accordance with an embodiment of the present disclosure, and illustrates the indication method as an example.

As shown in FIG. 18, the method includes:
1801, a network device determines that an AI encoder in a terminal equipment and/or an AI decoder in the network device are/is to be stopped;
1802, the network device transmits a request or a configuration or a signal for indicating to stop the AI encoder and/or the AI decoder; and
1803, the network device receives a response for indicating that the AI encoder and/or the AI decoder are/is to be stopped.

As shown in FIG. 18, the method further includes:
1804, the network device transmits one or more resources for PMI selection-based CSI reporting (codebook-based method, NR codebook type1, type 2, etype 2 or other type of codebook, e.g.). For example, the resources are configured or reconfigured via RRC, and/or activated via MAC CE, and/or scheduled via DCI.

It should be appreciated that FIG. 18 is only an example of the disclosure, it is not limited thereto. For example, the order of operations or steps may be adjusted and/or some operations or steps may be omitted. Moreover, some operations or steps not shown in FIG. 18 may be added.

In some embodiments, an AI/ML stop indication is initiated by a terminal equipment.

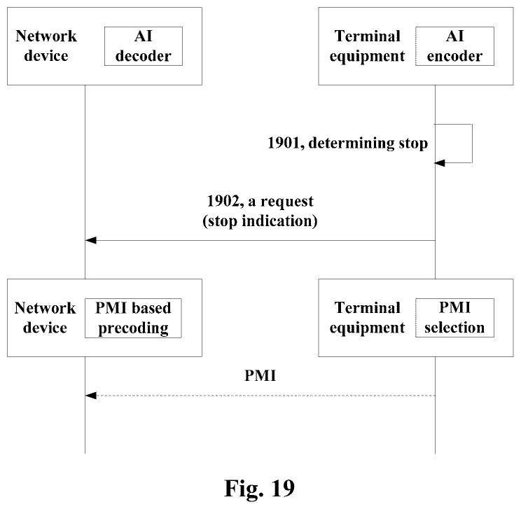

FIG. 19 is another schematic diagram which shows an indication method in accordance with an embodiment of the present disclosure, and illustrates the indication method as an example.

As shown in FIG. 19, the method includes:
1901, a terminal equipment determines that an AI encoder in the terminal equipment and/or an AI decoder in a network device are/is to be stopped;
1902, the terminal equipment transmits a request for indicating to stop the AI encoder and/or the AI decoder.

It should be appreciated that FIG. 19 is only an example of the disclosure, it is not limited thereto. For example, the order of operations or steps may be adjusted and/or some operations or steps may be omitted. Moreover, some operations or steps not shown in FIG. 19 may be added.

For example, the terminal equipment may detect AIpNN performance is bad and decide to stop it, or the terminal equipment have no enough computation power to support running its AI/ML network, or the terminal equipment want to save power and stop its AI/ML network. To synchronize the operation of AIpNN, the terminal equipment transmits an AI/ML stop indication.

As shown in FIG. 19, the network device switches from AI/ML based CSI decoding into precoding matrix indicator (PMI) based precoding. The terminal equipment switches from AI/ML based CSI encoding into precoding matrix indicator (PMI) selection.

In some embodiments, the terminal equipment may stop the neural network of its side first, and send the AI/ML stop indication to the network device, once upon receiving the indication, the network device stops the neural network of its side as well.

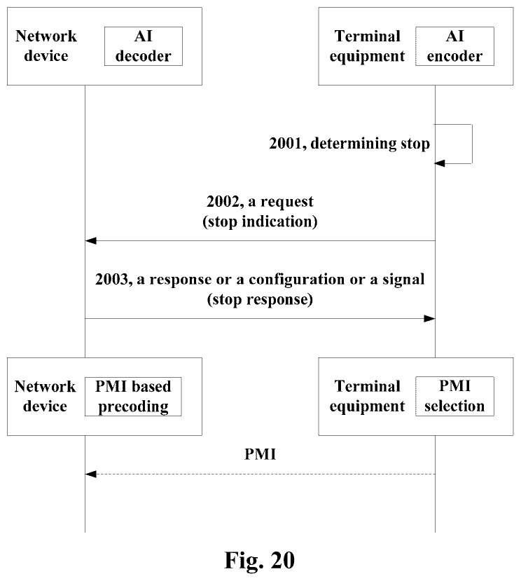

FIG. 20 is another schematic diagram which shows an indication method in accordance with an embodiment of the present disclosure, and illustrates the indication method as an example.

As shown in FIG. 20, the method includes:
2001, a terminal equipment determines that an AI encoder in the terminal equipment and/or an AI decoder in a network device are/is to be stopped;
2002, the terminal equipment transmits a request for indicating to stop the AI encoder and/or the AI decoder; and
2003, the terminal equipment receives a response or a configuration or a signal for indicating that the AI encoder and/or the AI decoder are/is to be stopped.

It should be appreciated that FIG. 20 is only an example of the disclosure, it is not limited thereto. For example, the order of operations or steps may be adjusted and/or some operations or steps may be omitted. Moreover, some operations or steps not shown in FIG. 20 may be added.

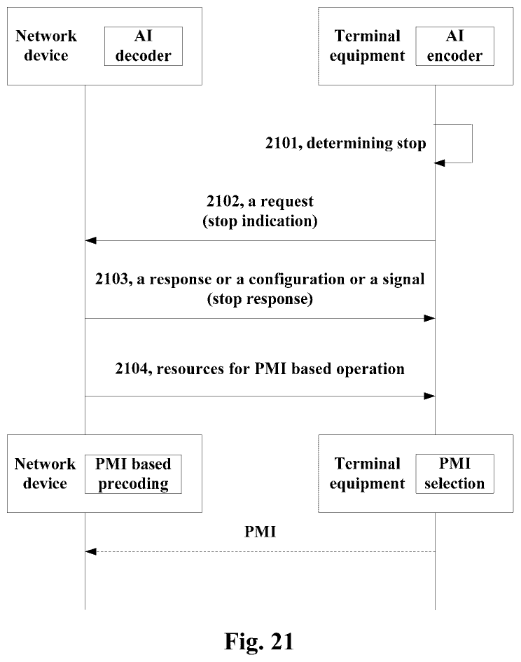

FIG. 21 is another schematic diagram which shows an indication method in accordance with an embodiment of the present disclosure, and illustrates the indication method as an example.

As shown in FIG. 21, the method includes:
2101, a terminal equipment determines that an AI encoder in the terminal equipment and/or an AI decoder in a network device are/is to be stopped;
2102, the terminal equipment transmits a request for indicating to stop the AI encoder and/or the AI decoder; and
2103, the terminal equipment receives a response or a configuration or a signal for indicating that the AI encoder and/or the AI decoder are/is to be stopped.

As shown in FIG. 21, the method further includes:
2104, the network device transmits one or more resources for PMI selection-based CSI reporting. For example, the resources are configured or reconfigured via RRC, and/or activated via MAC CE, and/or scheduled via DCI.

It should be appreciated that FIG. 21 is only an example of the disclosure, it is not limited thereto. For example, the order of operations or steps may be adjusted and/or some operations or steps may be omitted. Moreover, some operations or steps not shown in FIG. 21 may be added.

In some embodiments, the network device and the terminal equipment synchronize running or stopping the first AI/ML module and/or the second AI/ML module by using at least one of radio resource control message, media access control (MAC) control element (CE), or downlink control information (DCI).

For example, CSI reporting configuration may be aperiodic (such as using PUSCH), periodic (such as using PUCCH) or semi-persistent (such as using PUCCH, and DCI activated PUSCH). The CSI-RS resources may be periodic, semi-persistent, or aperiodic.

In order to handle running and stopping AI/ML based method for some CSI related quantities, such as channel quality indicator (CQI), precoding matrix indicator (PMI), CSI-RS resource indicator (CRI), SS/PBCH Block Resource indicator (SSBRI), layer indicator (LI), rank indicator (RI), L1-RSRP or L1-SINR, some parameters for indicating AI/ML based method may be added in CSI reporting configuration.

For example, adding one or more new entries in report quantity for AI/ML based method. In the case of AI encoder for CSI compression, the CSI quantity is given based on either input or output of the AI encoder. Besides, there are some parameters to enable and disable the AI/ML based method.

It is also possible to have one or more new entries not belonging to report quantity for AI/ML in CSI reporting configuration. These entries and parameters are given for indicating related information of AI/ML module, compression ratio of AI encoder, AI/ML update information, AI/ML based method is disabled or enabled.

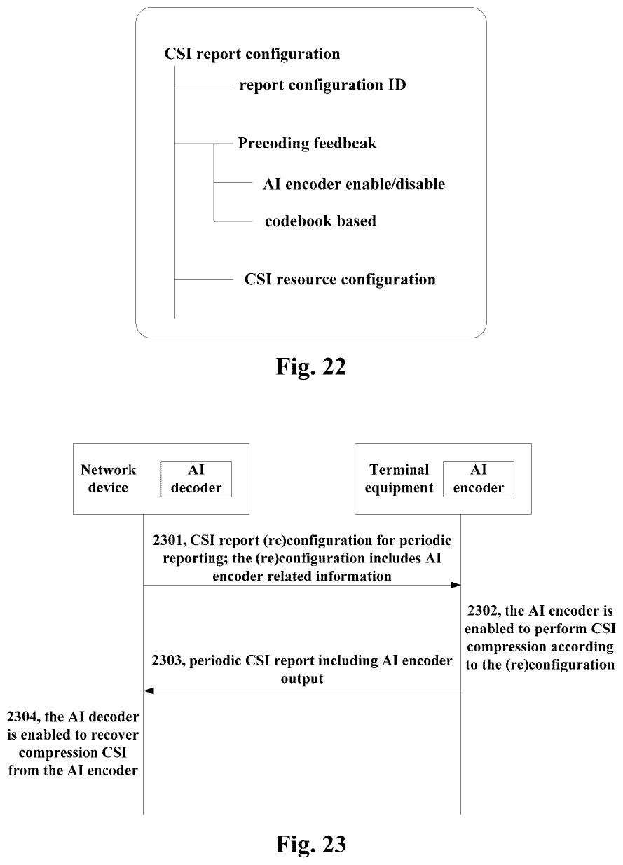

FIG. 22 is a schematic diagram which shows CSI report configuration in accordance with an embodiment of the present disclosure, and illustrates the configuration as an example.

As shown in FIG. 22, for example, there is a parameter in CSI report configuration to indicate the AI encoder and AI decoder being enabled (or run) or disabled (or stop). Besides, for an AI/ML based (such as AI encoder) CSI report quantity, its specific resource may be configured as well, or PMI related resource is reused.

It should be appreciated that FIG. 22 is only an example of the disclosure, it is not limited thereto. For example, other AI/ML related parameters need to be added in CSI report configuration in order to synchronize the AI encoder and AI decoder operations between the network device and the terminal equipment.

Next, the procedure for a CSI report with AI/ML based (such as AI encoder) CSI report quantity is explained according to periodic CSI reporting, semi-persistent CSI reporting, aperiodic CSI reporting respectively.

In some embodiment, for periodic CSI reporting, the network device and the terminal equipment are configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

FIG. 23 is another schematic diagram which shows an indication method in accordance with an embodiment of the present disclosure, and illustrates the indication method as an example. As shown in FIG. 23, the method includes:
2301, a network device transmits CSI report (re) configuration for periodic reporting; the (re) configuration includes AI encoder related information.
2302, in the terminal equipment, the AI encoder is enabled to perform CSI compression according to the (re) configuration.
2303, the terminal equipment transmits periodic CSI report including AI encoder output.
2304, in the network device, the AI decoder is enabled to recover compression CSI from the AI encoder.

It should be appreciated that FIG. 23 is only an example of the disclosure, it is not limited thereto. For example, the order of operations or steps may be adjusted and/or some operations or steps may be omitted. Moreover, some operations or steps not shown in FIG. 23 may be added.

For example, to start AI-based CSI reporting (AI encoder, AI decoder, e.g.), in the configuration of periodic CSI reporting, the entry related to AI based method is selected by the network device as one of the CSI-related quantities, the AI based method is enabled, and other AI related parameters and resource may be configured as well if needed. CSI report configuration with the periodic CSI reporting configuration are transmitted to the terminal equipment side.

Upon receiving the periodic CSI reporting configuration, the terminal equipment may use the reporting configuration and the resource configuration to measure the CSI-related quantities. The terminal equipment may use AI/ML (AI encoder e.g.) to calculate the CSI-related quantity with AI enable indication. According to report periodicity and offset configuration, CSI including AI-based CSI-related quantity (output of AI encoder, e.g.) is transmitted to the network device side via PUCCH.

There are two kind of situations which result stopping the AI-based CSI quantity method. In one case, the terminal equipment wants to stop the AI-based CSI reporting and transmits a stop request or indication to the network device. In the other case, the network device decides to stop the AI-based CSI reporting.

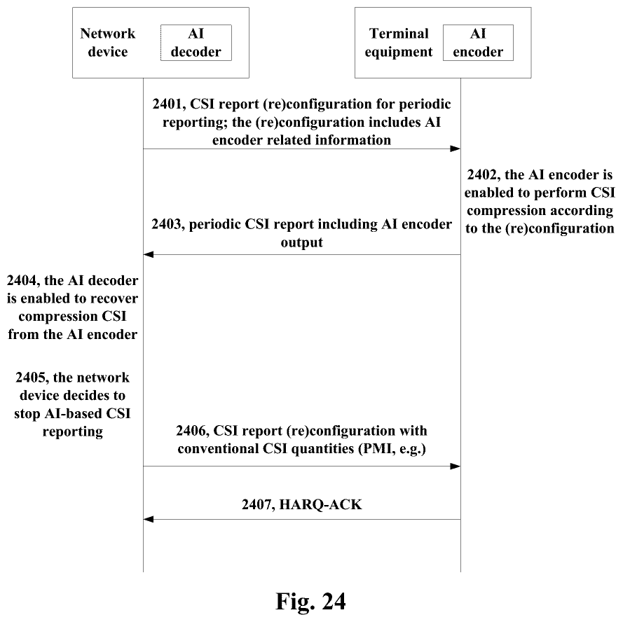

FIG. 24 is another schematic diagram which shows an indication method in accordance with an embodiment of the present disclosure, and illustrates the indication method as an example.

As shown in FIG. 24, the method includes:
2401, a network device transmits CSI report (re) configuration for periodic reporting; the (re) configuration includes AI encoder related information.
2402, in the terminal equipment, the AI encoder is enabled to perform CSI compression according to the (re) configuration.
2403, the terminal equipment transmits periodic CSI report including AI encoder output.
2404, in the network device, the AI decoder is enabled to recover compression CSI from the AI encoder.

In some situations, the network device decides to stop AI-based CSI reporting, as shown in FIG. 24, the method further includes:
2405, the network device decides to stop AI-based CSI reporting
2406, the network device transmits CSI report (re) configuration with related CSI quantities (PMI, e.g.).
2407, the terminal equipment transmits HARQ-ACK.

In the network device, the AI decoder is disabled, and the network device is switched to receive a related CSI report. In the terminal equipment, the AI encoder is disabled and performs the related CSI reporting according to the (re) configuration.

It should be appreciated that FIG. 24 is only an example of the disclosure, it is not limited thereto. For example, the order of operations or steps may be adjusted and/or some operations or steps may be omitted. Moreover, some operations or steps not shown in FIG. 24 may be added.

For example, the network device may use RRC reconfiguration to stop the AI-based CSI reporting (AI decoder and AI encoder, e.g.). the network device may reconfigure periodic CSI reporting configuration with AI-based CSI disabled and transmit the configuration to the terminal equipment side, or the network device may reconfigure related codebook-based CSI reporting configuration (codebook-based metric and parameters, NR codebook type1, type 2, etype 2 or other type of codebook, e.g.) and transmit the configuration to the terminal equipment side.

Upon receiving the new periodic CSI reporting configuration, the terminal equipment stops using AI in the CSI-related quantity calculation and stops the AI-based periodic CSI reporting via PUCCH. Instead, the terminal equipment switches to CSI report based on the new periodic CSI reporting configuration. In the network device side, the network device also stops using AI based method such as AI decoder to treat the CSI report after receiving ACK for the reconfiguration.

In some embodiments, for semi-persistent (SP) CSI reporting, the network device and the terminal equipment are configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

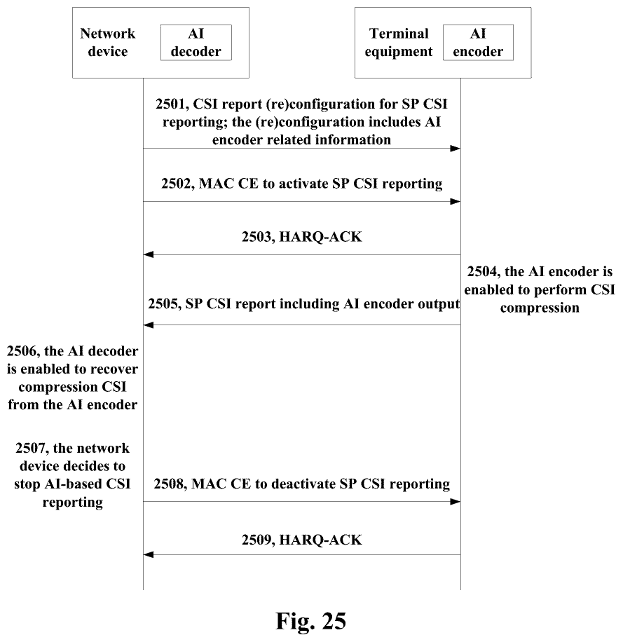

FIG. 25 is another schematic diagram which shows an indication method in accordance with an embodiment of the present disclosure, and illustrates the indication method as an example.

As shown in FIG. 25, the method includes:
2501, a network device transmits CSI report (re) configuration for semi-persistent reporting; the (re) configuration includes AI encoder related information.
2502, the network device transmits MAC CE (such as via PDSCH) to activate semi-persistent CSI reporting.
2503, the terminal equipment transmits HARQ-ACK. Therefore, MAC CE to activate AI-based CSI reporting is valid.
2504, in the terminal equipment, the AI encoder is enabled to perform CSI compression according to the MAC CE.
2505, the terminal equipment transmits semi-persistent CSI report including AI encoder output over PUCCH.
2506, in the network device, the AI decoder is enabled to recover compression CSI from the AI encoder.

In some situations, the network device decides to stop AI-based CSI reporting, as shown in FIG. 25, the method further includes:
2507, the network device decides to stop AI-based CSI reporting.
2508, the network device transmits MAC CE (such as via PDSCH) to deactivate semi-persistent CSI reporting.
2509, the terminal equipment transmits HARQ-ACK. Therefore, MAC CE to deactivate AI-based CSI reporting is valid.

In the network device, the AI decoder is disabled, and the network device is switched to receive a related CSI report. In the terminal equipment, the AI encoder is disabled and performs the related CSI reporting according to the MAC CE.

It should be appreciated that FIG. 25 is only an example of the disclosure, it is not limited thereto. For example, the order of operations or steps may be adjusted and/or some operations or steps may be omitted. Moreover, some operations or steps not shown in FIG. 25 may be added.

For example, to start AI-based CSI reporting (AI encoder, AI decoder, e.g.), in the configuration of SP CSI reporting, the entry related to AI based method is selected as one of the CSI-related quantities, and/or the AI based method is enabled. CSI report configuration with the SP CSI reporting configuration is transmitted to the terminal equipment side.

To activate SP CSI report, for reporting on PUCCH, the terminal equipment receives an activation command (MAC CE) from the network device; for reporting on PUSCH, the terminal equipment receives triggering on DCI from the network device.

Upon receiving the activation (MAC CE or DCI), the terminal equipment may use AI/ML (AI encoder e.g.) to calculate the CSI-related quantity with AI enable indication. According to the report periodicity and offset configuration, CSI including AI-based CSI-related quantity is transmitted to the network device side.

There are two kind of situations which result stopping the AI-based CSI reporting. In one case, the terminal equipment wants to stop the AI-based CSI reporting and transmits a stop request to the network device. In the other case, the network device decides to stop the AI-based CSI reporting.

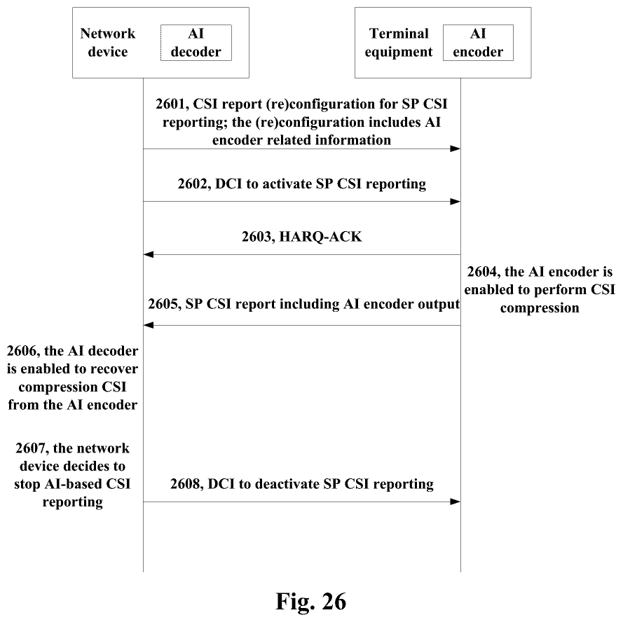

FIG. 26 is another schematic diagram which shows an indication method in accordance with an embodiment of the present disclosure, and illustrates the indication method as an example.

As shown in FIG. 26, the method includes:
2601, a network device transmits CSI report (re) configuration for SP CSI reporting; the (re) configuration includes AI encoder related information.
2602, the network device transmits DCI (such as via PDCCH) to activate semi-persistent CSI reporting.
2603, the terminal equipment transmits HARQ-ACK.
2604, in the terminal equipment, the AI encoder is enabled to perform CSI compression according to the DCI.
2605, the terminal equipment transmits SP CSI report including AI encoder output over PUSCH.
2606, in the network device, the AI decoder is enabled to recover compression CSI from the AI encoder.

In some situations, the network device decides to stop AI-based CSI reporting, as shown in FIG. 26, the method further includes:
2607, the network device decides to stop AI-based CSI reporting
2608, the network device transmits DCI (such as via PDCCH) to deactivate semi-persistent CSI reporting.

In the network device, the AI decoder is disabled, and the network device is switched to receive a related CSI report. In the terminal equipment, the AI encoder is disabled and performs the related CSI reporting according to the DCI.

It should be appreciated that FIG. 26 is only an example of the disclosure, it is not limited thereto. For example, the order of operations or steps may be adjusted and/or some operations or steps may be omitted. Moreover, some operations or steps not shown in FIG. 26 may be added.

For example, the network device may use MAC CE or DCI to stop the AI-based CSI reporting (AI decoder and AI encoder, e.g.). the network device may deactivate the AI-based SP CSI reporting via transmitting a MAC CE or a DCI. Upon receiving the deactivation command, the terminal equipment stops the AI-based CSI reporting.

In some embodiments, for aperiodic CSI reporting, the network device and the terminal equipment are configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

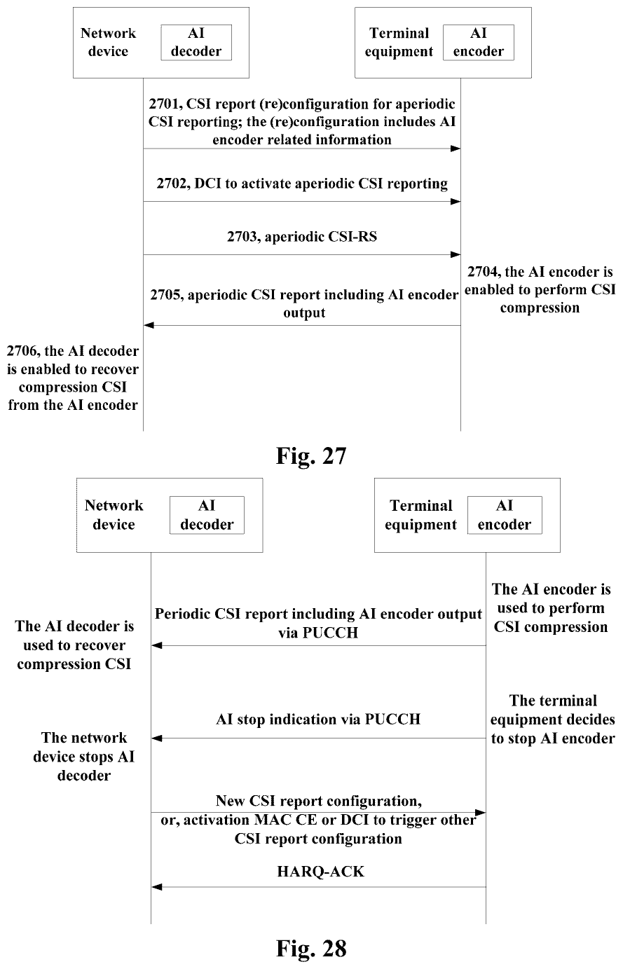

FIG. 27 is another schematic diagram which shows an indication method in accordance with an embodiment of the present disclosure, and illustrates the indication method as an example.

As shown in FIG. 27, the method includes:
2701, a network device transmits CSI report (re) configuration for aperiodic CSI reporting; the (re) configuration includes AI encoder related information.
2702, the network device transmits DCI (such as via PDCCH) to activate aperiodic CSI reporting.
2703, the network device transmits aperiodic CSI-RS.
2704, in the terminal equipment, the AI encoder is enabled to perform CSI compression according to the DCI.
2705, the terminal equipment transmits aperiodic CSI report including AI encoder output over PUSCH.
2706, in the network device, the AI decoder is enabled to recover compression CSI from the AI encoder.

It should be appreciated that FIG. 27 is only an example of the disclosure, it is not limited thereto. For example, the order of operations or steps may be adjusted and/or some operations or steps may be omitted. Moreover, some operations or steps not shown in FIG. 27 may be added.

For example, aperiodic CSI trigger list includes one or more CSI report configuration ID links to a CSI report configuration with AI-based CSI-related quantity method enabled and one or more CSI report configuration ID links to a CSI report configuration with AI-based CSI-related quantity method disabled. There is a codepoint links to the CSI report configuration ID. A DCI field for CSI request can indicate codepoint with AI-based CSI-related quantity method enabled, and the codepoint with AI-based CSI-related quantity method disabled.

To start AI-based CSI reporting (AI encoder, AI decoder, e.g.), the network device transmits a DCI with the codepoint links to AI-enabled CSI report configuration and related resource configuration. The terminal equipment is activated by this DCI.

Upon receiving a reference signal according to the resource configuration, the terminal equipment may use AI method (such as AI encoder) to generate AI-based CSI quantity. The aperiodic CSI report is transmitted to the network device via PUSCH according to the report configuration.

In the case of AI encoder/decoder, besides codebook (type1, type2, etype2, etc.) based feedback, format for AI-based feedback is predetermined. In addition, there is AI encoder stop indication, for example 1-bit indication. It is also possible there is a code with the same length of related codebook-based feedback, to indicate stopping AI encoder. For example, all “0” is used to indicate stopping AI encoder.

During period of a periodic CSI reporting or a SP CSI reporting, the terminal equipment may decide to stop AI or may have to stop its AI. In order to synchronize paired AI network in the network device and in the terminal equipment side, there are some ways as illustrated in the next description.

FIG. 28 is another schematic diagram which shows an indication method in accordance with an embodiment of the present disclosure, and illustrates the indication method as an example.

In one case, as shown in FIG. 28, the terminal equipment will stop its AI encoder first, and send the AI stop indication or AI stop code to the network device side via PUCCH. Before receiving new CSI report configuration or an activation for trigger new CSI report configuration (via MAC CE or DCI), the terminal equipment continues to send AI stop indication or AI stop code in PUCCH report timing.

Upon receiving this indication, the network device will stop its AI-based method (such as AI decoder). The network device will reconfigure a CSI report with related CSI quantities (codebook-based metric and parameters, NR codebook type1, type 2, etype 2 or other type of codebook, e.g.) and transmit to the terminal equipment side. The new CSI report configuration can be sent to the terminal equipment side by a periodic CSI report reconfiguration; or a MAC CE to activate SP CSI report; or a DCI to activate SP CSI report, or a DCI to activate AP CSI report.

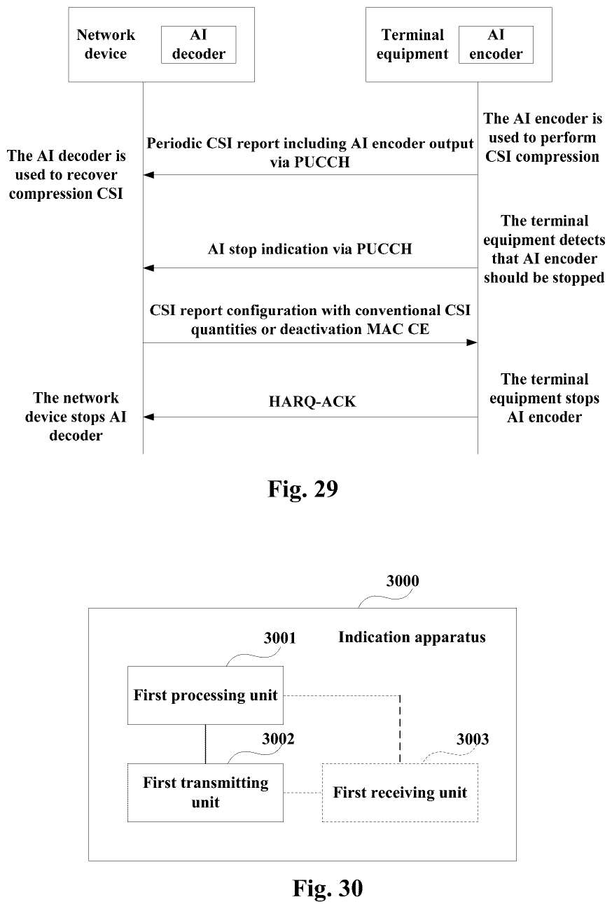

FIG. 29 is another schematic diagram which shows an indication method in accordance with an embodiment of the present disclosure, and illustrates the indication method as an example.

In another case, as shown in FIG. 29, the terminal equipment cannot stop its AI encoder first, the terminal equipment transmits the AI stop indication via PUCCH first, and keep using AI based method for its CSI report.

Upon detecting the AI stop indication, the network device may reconfigure a new CSI report with non-AI based CSI quantities, such as PMI, and transmits to the terminal equipment side. Alternatively, the network device may de-activate the CSI report via a MAC CE. After receiving the new configuration or the de-activation MAC CE, the terminal equipment will send ACK to the network device. Meanwhile, the terminal equipment will stop its AI based method, such as AI encoder. The network device will stop its AI decoder after getting the HARQ ACK.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

As can be seen from the above embodiments, a terminal equipment or a network device determines that an AI encoder and/or an AI decoder are/is to be stopped; and transmits a request for indicating to stop the AI encoder and/or the AI decoder. Therefore, AI/ML based CSI reporting can be switched into PMI based CSI reporting synchronously in the terminal equipment side and the network device side.

### Sixth Aspect of Embodiments

An indication apparatus is provided in an embodiment. The apparatus may be the terminal device 102 or may be configured in the terminal device 102, and the same contents as those in the first to fifth aspects of embodiments are omitted.

FIG. 30 shows a block diagram of an indication apparatus 3000 in accordance with an embodiment of the present disclosure.

As shown in FIG. 30, the indication apparatus 3000 includes: a first processing unit 3001, a first transmitting unit 3002 and a first receiving unit 3003. The first processing unit 3001 is configured to determine a first AI/ML module in the terminal equipment and/or a second AI/ML module in a network device are/is to be stopped; and the first transmitting unit 3002 is configured to transmit a request for indicating to stop the first AI/ML module and/or the second AI/ML module.

In some embodiments, the first receiving unit 3003 is configured to receive a response or a configuration or a signal for indicating that the first AI/ML module and/or the second AI/ML module are/is to be stopped; wherein AI/ML module is disabled in the configuration or there is not AI/ML related information in the configuration, or is deactivated via media access control (MAC) control element (CE) or downlink control information (DCI).

In some embodiments, the request is transmitted via physical uplink control channel (PUCCH), and confirmation of receiving the PUCCH is the configuration without AI/ML parameters.

In some embodiments, the request is transmitted via physical uplink shared channel (PUSCH) and the response is an acknowledge (ACK) of the PUSCH.

In some embodiments, the first receiving unit 3003 is configured to receive timing information for stopping the first AI/ML module and/or the second AI/ML module.

In some embodiments, the first transmitting unit 3002 is configured to transmit a response of the timing information.

In some embodiments, the timing information is transmitted via control information and/or data information; the control information comprises at least one of main information block (MIB), system information block (SIB), or downlink control information (DCI).

In some embodiments, the timing information is configured via radio resource control message and is activated via media access control (MAC) control element (CE) or downlink control information (DCI).

In some embodiments, the timing information is indicated via at least one of RRC configuration or reconfiguration, MAC CE activation or deactivation, or DCI activation or deactivation.

In some embodiments, the timing information is transmitted via physical downlink shared channel (PDSCH) and the response of the timing information is an acknowledge (ACK) of the PDSCH.

In some embodiments, the timing information comprises stopping time and/or step time of the first AI/ML module and/or the second AI/ML module.

In some embodiments, the terminal equipment determines the first AI/ML module and/or the second AI/ML module are/is to be stopped according to one or more signals from the network device and/or one or more parameters of the terminal equipment.

In some embodiments, the first processing unit 3001 is configured to stop the first AI/ML module in the terminal equipment; wherein the first AI/ML module in the terminal equipment and the second AI/ML module in the network device are stopped synchronously.

In some embodiments, the first AI/ML module and/or the second AI/ML module are/is used for channel state information (CSI) measurement; the first processing unit 3001 is configured to synchronize running or stopping the first AI/ML module and/or the second AI/ML module by using at least one of radio resource control message, media access control (MAC) control element (CE), or downlink control information (DCI).

In some embodiments, for periodic CSI reporting, the first processing unit 3001 is configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

In some embodiments, for semi-persistent CSI reporting or aperiodic CSI reporting, the first processing unit 3001 is configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

In some embodiments, the first processing unit 3001 is configured to determine a first AI/ML module in the terminal equipment and/or a second AI/ML module in a network device are/is to be started; and the first transmitting unit 3002 is configured to transmit a request for indicating to start the first AI/ML module and/or the second AI/ML module.

In some embodiments, the first receiving unit 3003 is configured to receive a response or a configured or a signal for indicating that the first AI/ML module and/or the second AI/ML module are/is to be started; wherein AI/ML module is enabled in the configuration or there is AI/ML related information in the configuration, or is activated via media access control (MAC) control element (CE) or downlink control information (DCI).

In some embodiments, the response is transmitted via control information and/or data information; the control information comprises at least one of main information block (MIB), system information block (SIB), or downlink control information (DCI).

In some embodiments, the request is transmitted via physical uplink shared channel (PUSCH) and the response is an acknowledge (ACK) of the PUSCH.

In some embodiments, the first receiving unit 3003 is configured to receive timing information for starting the first AI/ML module and/or the second AI/ML module.

In some embodiments, the timing information is transmitted via control information and/or data information; the control information comprises at least one of main information block (MIB), system information block (SIB), or downlink control information (DCI); or, the timing information is configured via radio resource control message and is activated via media access control (MAC) control element (CE) or downlink control information (DCI).

In some embodiments, the timing information comprises starting time and/or step time of the first AI/ML module and/or the second AI/ML module.

In some embodiments, the first processing unit 3001 determines the first AI/ML module and/or the second AI/ML module are/is to be started according to one or more signals from the network device and/or one or more parameters of the terminal equipment.

In some embodiments, the first receiving unit 3003 is configured to receive one or more resources for AI/ML operation from the network device.

In some embodiments, the first processing unit 3001 is configured to start the first AI/ML module in the terminal equipment; wherein the first AI/ML module in the terminal equipment and the second AI/ML module in the network device are started synchronously.

In some embodiments, the first AI/ML module and/or the second AI/ML module are/is used for channel state information (CSI) measurement; the first processing unit 3001 is configured to switch from precoding matrix indicator (PMI) selection into AI/ML based CSI encoding.

In some embodiments, the first receiving unit 3003 is configured to receive one or more resources for AI/ML based CSI encoding.

It should be appreciated that components included in the indication apparatus 3000 correspond to the operations of the above methods. Therefore, all operations and features described above with reference to above figures are likewise applicable to the components included in the indication apparatus 3000 and have similar effects. For the purpose of simplification, the details will be omitted.

It should be appreciated that the components included in the indication apparatus 3000 may be implemented in various manners, including software, hardware, firmware, or any combination thereof.

In an embodiment, one or more units may be implemented using software and/or firmware, for example, machine-executable instructions stored on the storage medium. In addition to or instead of machine-executable instructions, parts or all of the components included in the indication apparatus 3000 may be implemented, at least in part, by one or more hardware logic components.

For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The indication apparatus 3000 may be a part of a device. But it is not limited thereto, for example, the indication apparatus 3000 may be the terminal device 102, other parts of the terminal device 102, such as transmitter and receiver, are omitted in FIG. 30.

As can be seen from the above embodiments, a terminal equipment determines that a first AI/ML module in the terminal equipment and/or a second AI/ML module in a network device are/is to be stopped; and the terminal equipment transmits a request for indicating to stop the first AI/ML module and/or the second AI/ML module. Therefore, the AI/ML modules in a terminal equipment side and a network device side are turn off synchronously.

On the other hand, a terminal equipment determines that a first AI/ML module in the terminal equipment and/or a second AI/ML module in a network device are/is to be started; and the terminal equipment transmits a request for indicating to start the first AI/ML module and/or the second AI/ML module. Therefore, the AI/ML modules in a terminal equipment side and a network device side are turn on synchronously.

### Seventh Aspect of Embodiments

An indication apparatus is provided in an embodiment. The apparatus may be the network device 101 or may be configured in the network device 101, and the same contents as those in the first to fifth aspects of embodiments are omitted.

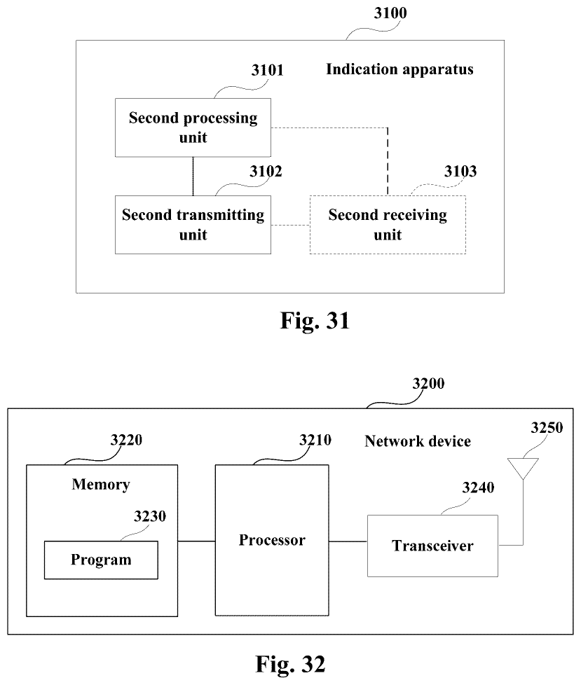

FIG. 31 shows a block diagram of an indication apparatus 3100 in accordance with an embodiment of the present disclosure.

As shown in FIG. 31, the apparatus 3100 includes: a second processing unit 3101, a second transmitting unit 3102 and a second receiving unit 3103. The second processing unit 3101 is configured to determine a first AI/ML module in the terminal equipment and/or a second AI/ML module in the network device are/is to be stopped; and the second transmitting unit 3102 is configured to transmit a request or a configuration or a signal for indicating to stop the first AI/ML module and/or the second AI/ML module; wherein AI/ML module is disabled in the configuration or there is not AI/ML related information in the configuration, or is deactivated via media access control (MAC) control element (CE) or downlink control information (DCI).

In some embodiments, the second receiving unit 3103 is configured to receive a response for indicating that the first AI/ML module and/or the second AI/ML module are/is to be stopped.

In some embodiments, the request is transmitted via physical downlink control channel (PDCCH) and/or physical downlink shared channel (PDSCH).

In some embodiments, the request is transmitted via physical downlink shared channel (PDSCH) and the response is an acknowledge (ACK) of the PDSCH.

In some embodiments, the second transmitting unit 3102 is configured to transmit timing information for stopping the first AI/ML module and/or the second AI/ML module.

In some embodiments, the timing information is transmitted via control information and/or data information; the control information comprises at least one of main information block (MIB), system information block (SIB), or downlink control information (DCI).

In some embodiments, the timing information is configured via radio resource control message and is activated via media access control (MAC) control element (CE) or downlink control information (DCI).

In some embodiments, the timing information is indicated via at least one of RRC configuration or reconfiguration, MAC CE activation or deactivation, or DCI activation or deactivation.

In some embodiments, the timing information is transmitted via physical downlink shared channel (PDSCH) and the response of the timing information is an acknowledge (ACK) of the PDSCH.

In some embodiments, the timing information comprises stopping time and/or step time of the first AI/ML module and/or the second AI/ML module.

In some embodiments, the second processing unit 3101 determines the first AI/ML module and/or the second AI/ML module are/is to be stopped according to one or more signals from the terminal equipment and/or one or more parameters of the network device.

In some embodiments, the second processing unit 3101 is configured to stop the second AI/ML module in the network device; wherein the first AI/ML module in the terminal equipment and the second AI/ML module in the network device are stopped synchronously.

In some embodiments, the first AI/ML module and/or the second AI/ML module are/is used for channel state information (CSI) measurement; the second processing unit 3101 is configured to synchronize running or stopping the first AI/ML module and/or the second AI/ML module by using at least one of radio resource control message, media access control (MAC) control element (CE), or downlink control information (DCI).

In some embodiments, for periodic CSI reporting, the second processing unit 3101 is configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

In some embodiments, for semi-persistent CSI reporting or aperiodic CSI reporting, the second processing unit 3101 is configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

In some embodiments, the second transmitting unit 3102 is configured to transmit one or more resources for PMI selection-based CSI reporting.

In some embodiments, the second processing unit 3101 is configured to determine a first AI/ML module in the terminal equipment and/or a second AI/ML module in the network device are/is to be started; and the second transmitting unit 3102 is configured to transmit a request or a configuration or a signal for indicating to start the first AI/ML module and/or the second AI/ML module, wherein AI/ML module is enabled in the configuration or there is AI/ML related information in the configuration, or is activated via media access control (MAC) control element (CE) or downlink control information (DCI).

In some embodiments, the second receiving unit 3103 is configured to receive a response for indicating that the first AI/ML module and/or the second AI/ML module are/is to be started.

In some embodiments, the request is transmitted via control information and/or data information; the control information comprises at least one of main information block (MIB), system information block (SIB), or downlink control information (DCI).

In some embodiments, the request is transmitted via physical downlink shared channel (PDSCH) and the response is an acknowledge (ACK) of the PDSCH.

In some embodiments, the second transmitting unit 3102 is configured to transmit timing information for starting the first AI/ML module and/or the second AI/ML module.

In some embodiments, the timing information is transmitted via control information and/or data information; the control information comprises at least one of main information block (MIB), system information block (SIB), or downlink control information (DCI); or, the timing information is configured via radio resource control message and is activated via media access control (MAC) control element (CE) or downlink control information (DCI).

In some embodiments, the timing information comprises starting time and/or step time of the first AI/ML module and/or the second AI/ML module.

In some embodiments, the second processing unit 3101 determines the first AI/ML module and/or the second AI/ML module are/is to be started according to one or more signals from the terminal equipment and/or one or more parameters of the network device.

In some embodiments, the second transmitting unit 3102 is configured to transmit one or more resources for AI/ML operation to the terminal equipment.

In some embodiments, the second processing unit 3101 is configured to start the second AI/ML module in the network device; wherein the first AI/ML module in the terminal equipment and the second AI/ML module in the network device are started synchronously.

In some embodiments, the first AI/ML module and/or the second AI/ML module are/is used for channel state information (CSI) measurement; the second processing unit 3101 is configured to switch from precoding matrix indicator (PMI) based precoding into AI/ML based CSI decoding.

In some embodiments, the second transmitting unit 3102 is configured to transmit one or more resources for AI/ML based CSI encoding.

It should be appreciated that components included in the indication apparatus 3100 correspond to the operations of the above methods. Therefore, all operations and features described above with reference to above figures are likewise applicable to the components included in the indication apparatus 3100 and have similar effects. For the purpose of simplification, the details will be omitted.

It should be appreciated that the components included in the indication apparatus 3100 may be implemented in various manners, including software, hardware, firmware, or any combination thereof.

In an embodiment, one or more units may be implemented using software and/or firmware, for example, machine-executable instructions stored on the storage medium. In addition to or instead of machine-executable instructions, parts or all of the components included in the indication apparatus 3100 may be implemented, at least in part, by one or more hardware logic components.

For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The indication apparatus 3100 may be a part of a device. But it is not limited thereto, for example, the indication apparatus 3100 may be the network device 101, other parts of the network device 101, such as transmitter and receiver, are omitted in FIG. 31.

As can be seen from the above embodiments, a network device determines that a first AI/ML module in a terminal equipment and/or a second AI/ML module in a network device are/is to be stopped; and the network device transmits a request for indicating to stop the first AI/ML module and/or the second AI/ML module. Therefore, the AI/ML modules in a terminal equipment side and a network device side are turn off synchronously.

On the other hand, a network device determines that a first AI/ML module in a terminal equipment and/or a second AI/ML module in a network device are/is to be started; and the network device transmits a request for indicating to start the first AI/ML module and/or the second AI/ML module. Therefore, the AI/ML modules in a terminal equipment side and a network device side are turn on synchronously.

### Eighth Aspect of Embodiments

The embodiments of this disclosure provide a communication system, and reference may be made to FIG. 1, with contents identical to those in the embodiments of the first to the fourth aspect being not going to be described herein any further.

In some embodiments, the communication system 100 may include:
a terminal equipment 102 configured to determine a first AI/ML module in a terminal equipment and/or a second AI/ML module in a network device are/is to be stopped; and transmit to the network device a request for indicating to stop the first AI/ML module and/or the second AI/ML module; and
a network device 101 configured to receive the request for indicating to stop the first AI/ML module and/or the second AI/ML module.

In some embodiments, the communication system 100 may include:
a terminal equipment 102 configured to determine a first AI/ML module in a terminal equipment and/or a second AI/ML module in a network device are/is to be started; and transmit to the network device a request for indicating to start the first AI/ML module and/or the second AI/ML module; and
a network device 101 configured to receive the request for indicating to start the first AI/ML module and/or the second AI/ML module.

In some embodiments, the communication system 100 may include:
a network device 101 configured to determine a first AI/ML module in a terminal equipment and/or a second AI/ML module in a network device are/is to be stopped; and transmit to the terminal equipment a request for indicating to stop the first AI/ML module and/or the second AI/ML module; and
a terminal equipment 102 configured to receive the request for indicating to stop the first AI/ML module and/or the second AI/ML module.

In some embodiments, the communication system 100 may include:
a network device 101 configured to determine a first AI/ML module in a terminal equipment and/or a second AI/ML module in a network device are/is to be started; and transmit to the terminal equipment a request for indicating to start the first AI/ML module and/or the second AI/ML module; and
a terminal equipment 102 configured to receive the request for indicating to start the first AI/ML module and/or the second AI/ML module.

The embodiment of this disclosure further provides a network device, which may be, for example, a base station. However, this disclosure is not limited thereto, and it may also be another network device.

FIG. 32 is a schematic diagram of the network device of the embodiment of this disclosure. As shown in FIG. 32, the network device 3200 may include a processor 3210 (such as a central processing unit (CPU)) and a memory 3220, the memory 3220 being coupled to the processor 3210. The memory 3220 may store various data, and furthermore, it may store a program 3230 for data processing, and execute the program 3230 under control of the processor 3210.

For example, the processor 3210 may be configured to execute the program to carry out the indication method as described in the first to fourth aspects of embodiments. For example, the processor 3210 may be configured to execute the following control: determining a first AI/ML module in the terminal equipment and/or a second AI/ML module in the network device are/is to be stopped; and transmitting, to the terminal equipment, a request or a configuration or a signal for indicating to stop the first AI/ML module and/or the second AI/ML module.

For another example, the processor 3210 may be configured to execute the following control: determining a first AI/ML module in the terminal equipment and/or a second AI/ML module in the network device are/is to be started; and transmitting, to the terminal equipment, a request or a configuration or a signal for indicating to start the first AI/ML module and/or the second AI/ML module.

Furthermore, as shown in FIG. 32, the network device 3200 may include a transceiver 3240, and an antenna 3250, etc. Functions of the above components are similar to those in the related art, and shall not be described herein any further. It should be noted that the network device 3200 does not necessarily include all the parts shown in FIG. 32, and furthermore, the network device 3200 may include parts not shown in FIG. 32, and the related art may be referred to.

The embodiment of this disclosure further provides a terminal equipment; however, this disclosure is not limited thereto, and it may also be another equipment.

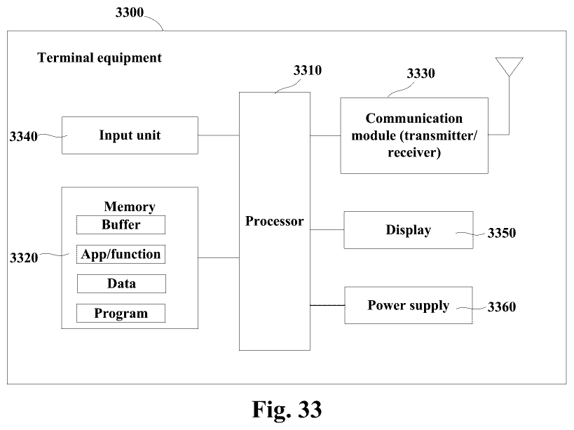

FIG. 33 is a schematic diagram of the terminal equipment of the embodiment of this disclosure. As shown in FIG. 33, a terminal equipment 3300 may include a processor 3310 and a memory 3320, the memory 3320 storing data and a program and being coupled to the processor 3310. It should be noted that this figure is illustrative only, and other types of structures may also be used, so as to supplement or replace this structure and achieve a telecommunications function or other functions.

For example, the processor 3310 may be configured to execute a program to carry out the indication method as described in the first to fourth aspects of embodiments. For example, the processor 3310 may be configured to perform the following control: determining a first AI/ML module in the terminal equipment and/or a second AI/ML module in a network device are/is to be stopped; and transmitting, to the network device, a request for indicating to stop the first AI/ML module and/or the second AI/ML module.

For another example, the processor 3310 may be configured to perform the following control: determining a first AI/ML module in the terminal equipment and/or a second AI/ML module in a network device are/is to be started; and transmitting, to the network device, a request for indicating to start the first AI/ML module and/or the second AI/ML module.

As shown in FIG. 33, the terminal equipment 3300 may further include a communication module 3330, an input unit 3340, a display 3350, and a power supply 3360; wherein functions of the above components are similar to those in the related art, which shall not be described herein any further. It should be noted that the terminal equipment 3300 does not necessarily include all the parts shown in FIG. 33, and the above components are not necessary. Furthermore, the terminal equipment 3300 may include parts not shown in FIG. 33, and the related art may be referred to.

An embodiment of this disclosure provides a computer program, which, when executed in a terminal equipment, will cause the terminal equipment to carry out the indication method as described in the first to fourth aspects of embodiments.

An embodiment of this disclosure provides a storage medium, including a computer program, which, when executed in a terminal equipment, will cause the terminal equipment to carry out the indication method as described in the first to fourth aspects of embodiments.

An embodiment of this disclosure provides a computer program, which, when executed in a network device, will cause the network device to carry out the indication method as described in the first to fourth aspects of embodiments.

An embodiment of this disclosure provides a storage medium, including a computer program, which, when executed in a network device, will cause the network device to carry out the indication method as described in the first to fourth aspects of embodiments.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

1. An indication method, comprising:
determining, by a terminal equipment, a first AI/ML module in the terminal equipment and/or a second AI/ML module in a network device are/is to be stopped; and
transmitting, by the terminal equipment to the network device, a request for indicating to stop the first AI/ML module and/or the second AI/ML module.

2. The method according to supplement 1, wherein the method further comprises:
receiving, by the terminal equipment from the network device, a response or a configuration or a signal for indicating that the first AI/ML module and/or the second AI/ML module are/is to be stopped; wherein AI/ML module is disabled in the configuration or there is not AI/ML related information in the configuration, or is deactivated via media access control (MAC) control element (CE) or downlink control information (DCI).

3. The method according to supplement 1, wherein the request is transmitted via physical uplink control channel (PUCCH), and/or, the request is transmitted via physical uplink shared channel (PUSCH).

4. The method according to supplement 2, wherein the request is transmitted via physical uplink control channel (PUCCH), and confirmation of receiving the PUCCH is the configuration without AI/ML parameters.

5. The method according to supplement 2, wherein the request is transmitted via physical uplink shared channel (PUSCH) and the response is an acknowledge (ACK) of the PUSCH.

6. The method according to any one of supplements 1-5, wherein the method further comprises:
receiving, by the terminal equipment from the network device, timing information for stopping the first AI/ML module and/or the second AI/ML module.

7. The method according to supplement 6, wherein the method further comprises:
transmitting, by the terminal equipment to the network device, a response of the timing information.

8. The method according to supplement 6, wherein the timing information is transmitted via control information and/or data information; the control information comprises at least one of main information block (MIB), system information block (SIB), or downlink control information (DCI).

9. The method according to supplement 6, wherein the timing information is configured via radio resource control message and is activated via media access control (MAC) control element (CE) or downlink control information (DCI).

10. The method according to supplement 6, wherein the timing information is indicated via at least one of RRC configuration or reconfiguration, MAC CE activation or deactivation, or DCI activation or deactivation.

11. The method according to supplement 7, wherein the timing information is transmitted via physical downlink shared channel (PDSCH) and the response of the timing information is an acknowledge (ACK) of the PDSCH.

12. The method according to any one of supplements 6-11, wherein the timing information comprises stopping time and/or step time of the first AI/ML module and/or the second AI/ML module.

13. The method according to any one of supplements 1-12, wherein the terminal equipment determines the first AI/ML module and/or the second AI/ML module are/is to be stopped according to one or more signals from the network device and/or one or more parameters of the terminal equipment.

14. The method according to any one of supplements 1-13, wherein the method further comprises:
stopping, by the terminal equipment, the first AI/ML module in the terminal equipment;
wherein the first AI/ML module in the terminal equipment and the second AI/ML module in the network device are stopped synchronously.

15. The method according to any one of supplements 1-14, wherein the first AI/ML module and/or the second AI/ML module are/is used for channel state information (CSI) measurement; the method further comprises:
synchronizing, by the terminal equipment, running or stopping the first AI/ML module and/or the second AI/ML module by using at least one of radio resource control message, media access control (MAC) control element (CE), or downlink control information (DCI).

16. The method according to supplement 15, wherein for periodic CSI reporting, the second processing unit is configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

17. The method according to supplement 15, wherein for semi-persistent CSI reporting or aperiodic CSI reporting, the second processing unit is configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

18. An indication method, comprising:
determining, by a network device, a first AI/ML module in the terminal equipment and/or a second AI/ML module in the network device are/is to be stopped; and
transmitting, by the network device to the terminal equipment, a request or a configuration or a signal for indicating to stop the first AI/ML module and/or the second AI/ML module; wherein AI/ML module is disabled in the configuration or there is not AI/ML related information in the configuration, or is deactivated via media access control (MAC) control element (CE) or downlink control information (DCI).

19. The method according to supplement 18, wherein the method further comprises:
receiving, by the network device from the terminal equipment, a response for indicating that the first AI/ML module and/or the second AI/ML module are/is to be stopped.

20. The method according to supplement 18, wherein the request is transmitted via physical downlink control channel (PDCCH) and/or physical downlink shared channel (PDSCH).

21. The method according to supplement 19, wherein the request is transmitted via physical downlink shared channel (PDSCH) and the response is an acknowledge (ACK) of the PDSCH.

22. The method according to any one of supplements 18-21, wherein the method further comprises:
transmitting, by the network device to the terminal equipment, timing information for stopping the first AI/ML module and/or the second AI/ML module.

23. The method according to supplement 22, wherein the timing information is transmitted via control information and/or data information; the control information comprises at least one of main information block (MIB), system information block (SIB), or downlink control information (DCI).

24. The method according to supplement 22, wherein the timing information is configured via radio resource control message and is activated via media access control (MAC) control element (CE) or downlink control information (DCI).

25. The method according to supplement 22, wherein the timing information is indicated via at least one of RRC configuration or reconfiguration, MAC CE activation or deactivation, or DCI activation or deactivation.

26. The method according to supplement 22, wherein the timing information is transmitted via physical downlink shared channel (PDSCH) and the response of the timing information is an acknowledge (ACK) of the PDSCH.

27. The method according to supplement 23, wherein the timing information comprises stopping time and/or step time of the first AI/ML module and/or the second AI/ML module.

28. The method according to any one of supplements 18-27, wherein the network device determines the first AI/ML module and/or the second AI/ML module are/is to be stopped according to one or more signals from the terminal equipment and/or one or more parameters of the network device.

29. The method according to any one of supplements 18-27, wherein the method further comprises:
stopping, by the network device, the second AI/ML module in the network device;
wherein the first AI/ML module in the terminal equipment and the second AI/ML module in the network device are stopped synchronously.

30. The method according to any one of supplements 18-27, wherein the first AI/ML module and/or the second AI/ML module are/is used for channel state information (CSI) measurement; the method further comprises:
synchronizing, by the network device, running or stopping the first AI/ML module and/or the second AI/ML module by using at least one of radio resource control message, media access control (MAC) control element (CE), or downlink control information (DCI).

31. The method according to supplement 30, wherein for periodic CSI reporting, the second processing unit is configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

32. The method according to supplement 30, wherein for semi-persistent CSI reporting or aperiodic CSI reporting, the second processing unit is configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

33. An indication method, comprising:
determining, by a terminal equipment, a first AI/ML module in the terminal equipment and/or a second AI/ML module in a network device are/is to be started; and
transmitting, by the terminal equipment to the network device, a request for indicating to start the first AI/ML module and/or the second AI/ML module.

34. The method according to supplement 33, wherein the method further comprises:
receiving, by the terminal equipment from the network device, a response or a configuration or a signal for indicating that the first AI/ML module and/or the second AI/ML module are/is to be started; wherein AI/ML module is enabled in the configuration or there is AI/ML related information in the configuration, or is activated via media access control (MAC) control element (CE) or downlink control information (DCI).

35. The method according to supplement 34, wherein the response is transmitted via control information and/or data information; the control information comprises at least one of main information block (MIB), system information block (SIB), or downlink control information (DCI).

36. The method according to supplement 34, wherein the request is transmitted via physical uplink control channel (PUCCH), and confirmation of receiving the PUCCH is the configuration with AI/ML parameter.

37. The method according to supplement 34, wherein the request is transmitted via physical uplink shared channel (PUSCH) and the response is an acknowledge (ACK) of the PUSCH.

38. The method according to any one of supplements 33-37, wherein the method further comprises:
receiving, by the terminal equipment from the network device, timing information for starting the first AI/ML module and/or the second AI/ML module.

39. The method according to supplement 38, wherein the timing information is transmitted via control information and/or data information; the control information comprises at least one of main information block (MIB), system information block (SIB), or downlink control information (DCI).

40. The method according to supplement 38, wherein the timing information is configured via radio resource control message and is activated via media access control (MAC) control element (CE) or downlink control information (DCI).

41. The method according to supplement 38, wherein the timing information is indicated via at least one of RRC configuration or reconfiguration, MAC CE activation or deactivation, or DCI activation or deactivation.

42. The method according to supplement 38, wherein the timing information is transmitted via physical downlink shared channel (PDSCH) and the response of the timing information is an acknowledge (ACK) of the PDSCH.

43. The method according to supplement 39, wherein the timing information comprises starting time and/or step time of the first AI/ML module and/or the second AI/ML module.

44. The method according to any one of supplements 33-43, wherein the terminal equipment determines the first AI/ML module and/or the second AI/ML module are/is to be started according to one or more signals from the network device and/or one or more parameters of the terminal equipment.

45. The method according to any one of supplements 33-44, wherein the method further comprises:
receiving one or more resources for AI/ML operation from the network device.

46. The method according to any one of supplements 33-45, wherein the method further comprises:
starting, by the terminal equipment, the first AI/ML module in the terminal equipment;
wherein the first AI/ML module in the terminal equipment and the second AI/ML module in the network device are started synchronously.

47. The method according to any one of supplements 33-45, wherein the first AI/ML module and/or the second AI/ML module are/is used for channel state information (CSI) measurement; the method further comprises:
synchronizing, by the terminal equipment, running or stopping the first AI/ML module and/or the second AI/ML module by using at least one of radio resource control message, media access control (MAC) control element (CE), or downlink control information (DCI).

48. The method according to supplement 47, wherein for periodic CSI reporting, the first processing unit is configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

49. The method according to supplement 47, wherein for semi-persistent CSI reporting or aperiodic CSI reporting, the first processing unit is configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

50. An indication method, comprising:
determining, by a network device, a first AI/ML module in the terminal equipment and/or a second AI/ML module in the network device are/is to be started; and
transmitting, by the network device to the terminal equipment, a request or a configuration or a signal for indicating to start the first AI/ML module and/or the second AI/ML module; wherein AI/ML module is enabled in the configuration or there is AI/ML related information in the configuration, or is activated via media access control (MAC) control element (CE) or downlink control information (DCI).

51. The method according to supplement 50, wherein the method further comprises:
receiving, by the network device from the terminal equipment, a response for indicating that the first AI/ML module and/or the second AI/ML module are/is to be started.

52. The method according to supplement 50, wherein the request is transmitted via control information and/or data information; the control information comprises at least one of main information block (MIB), system information block (SIB), or downlink control information (DCI).

53. The method according to supplement 51, wherein the request is transmitted via physical downlink shared channel (PDSCH) and the response is an acknowledge (ACK) of the PDSCH.

54. The method according to any one of supplements 50-53, wherein the method further comprises:
transmitting, by the network device to the terminal equipment, timing information for starting the first AI/ML module and/or the second AI/ML module.

55. The method according to supplement 54, wherein the timing information is transmitted via control information and/or data information; the control information comprises at least one of main information block (MIB), system information block (SIB), or downlink control information (DCI).

56. The method according to supplement 54, wherein the timing information is configured via radio resource control message and is activated via media access control (MAC) control element (CE) or downlink control information (DCI).

57. The method according to supplement 54, wherein the timing information is indicated via at least one of RRC configuration or reconfiguration, MAC CE activation or deactivation, or DCI activation or deactivation.

58. The method according to supplement 54, wherein the timing information is transmitted via physical downlink shared channel (PDSCH) and the response of the timing information is an acknowledge (ACK) of the PDSCH.

59. The method according to supplement 54, wherein the timing information comprises starting time and/or step time of the first AI/ML module and/or the second AI/ML module.

60. The method according to any one of supplements 50-59, wherein the network device determines the first AI/ML module and/or the second AI/ML module are/is to be started according to one or more signals from the terminal equipment and/or one or more parameters of the network device.

61. The method according to any one of supplements 50-60, wherein the method further comprises:
transmitting one or more resources for AI/ML operation to the terminal equipment.

62. The method according to any one of supplements 50-61, wherein the method further comprises:
starting, by the network device, the second AI/ML module in the network device;
wherein the first AI/ML module in the terminal equipment and the second AI/ML module in the network device are started synchronously.

63. The method according to any one of supplements 50-61, wherein the first AI/ML module and/or the second AI/ML module are/is used for channel state information (CSI) measurement; the method further comprises:
synchronizing, by the network device, running or stopping the first AI/ML module and/or the second AI/ML module by using at least one of radio resource control message, media access control (MAC) control element (CE), or downlink control information (DCI).

64. The method according to supplement 63, wherein for periodic CSI reporting, the second processing unit is configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

65. The method according to supplement 63, wherein for semi-persistent CSI reporting or aperiodic CSI reporting, the second processing unit is configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

66. A terminal equipment, comprising a processor and a memory, wherein the memory containing instructions executable by the processor whereby the terminal equipment is operative to perform a method according to any of supplements 1-17 and 34-49.

67. A network device, comprising a processor and a memory, wherein the memory containing instructions executable by the processor whereby the network device is operative to perform a method according to any of supplements 18-33 and 51-65.

68. A computer program product being tangibly stored on a computer readable storage medium and including instructions which, when executed on a processor of a terminal device, cause the terminal equipment to perform a method according to any of supplements 1-17 and 34-49.

69. A computer program product being tangibly stored on a computer readable storage medium and including instructions which, when executed on a processor of a network device, cause the network device to perform a method according to any of supplements 18-33 and 51-65.

What is claimed is:

1. An indication apparatus, comprising:
first processor circuitry configured to determine a first AI/ML module in a terminal equipment and/or a second AI/ML module in a network device are/is to be stopped; and
a first transmitter configured to transmit to the network device a request for indicating to stop the first AI/ML module and/or the second AI/ML module.

2. The apparatus according to claim 1, the apparatus further comprising:
a first receiver configured to receive a response or a configuration or a signal for indicating that the first AI/ML module and/or the second AI/ML module are/is to be stopped; wherein AI/ML module is disabled in the configuration or there is not AI/ML related information in the configuration, or is deactivated via media access control (MAC) control element (CE) or downlink control information (DCI).

3. The apparatus according to claim 2, wherein the request is transmitted via physical uplink control channel (PUCCH), and confirmation of receiving the PUCCH is the configuration without AI/ML parameters,
or, the request is transmitted via physical uplink shared channel (PUSCH) and the response is an acknowledge (ACK) of the PUSCH.

4. The apparatus according to claim 2, wherein the first receiver is further configured to receive timing information for stopping the first AI/ML module and/or the second AI/ML module;
the first transmitter is further configured to transmit a response of the timing information.

5. The apparatus according to claim 4, wherein the timing information is transmitted via control information and/or data information; the control information comprises at least one of main information block (MIB), system information block (SIB), or downlink control information (DCI); and/or,
the timing information is configured via radio resource control message and is activated via media access control (MAC) control element (CE) or downlink control information (DCI); and/or,
the timing information is indicated via at least one of RRC configuration or reconfiguration, MAC CE activation or deactivation, or DCI activation or deactivation; and/or,
the timing information is transmitted via physical downlink shared channel (PDSCH) and the response of the timing information is an acknowledge (ACK) of the PDSCH.

6. The apparatus according to claim 4, wherein the timing information comprises stopping time and/or step time of the first AI/ML module and/or the second AI/ML module.

7. The apparatus according to claim 1, wherein the first processor circuitry determines the first AI/ML module and/or the second AI/ML module are/is to be stopped according to one or more signals from the network device and/or one or more parameters of the terminal equipment;
the first processor circuitry is configured to stop the first AI/ML module in the terminal equipment; wherein the first AI/ML module in the terminal equipment and the second AI/ML module in the network device are stopped synchronously.

8. The apparatus according to claim 1, wherein the first AI/ML module and/or the second AI/ML module are/is used for channel state information (CSI) measurement;
the first processor circuitry is configured to synchronize running or stopping the first AI/ML module and/or the second AI/ML module by using at least one of radio resource control message, media access control (MAC) control element (CE), or downlink control information (DCI).

9. The apparatus according to claim 8, wherein
for periodic CSI reporting, the first processor circuitry is configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

10. The apparatus according to claim 8, wherein
for semi-persistent CSI reporting or aperiodic CSI reporting, the first processor circuitry is configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

11. An indication apparatus, comprising:
second processor circuitry, configured to determine a first AI/ML module in a terminal equipment and/or a second AI/ML module in a network device are/is to be stopped; and
a second transmitter configured to transmit to the terminal equipment a request or a configuration or a signal for indicating to stop the first AI/ML module and/or the second AI/ML module; wherein AI/ML module is disabled in the configuration or there is not AI/ML related information in the configuration, or is deactivated via media access control (MAC) control element (CE) or downlink control information (DCI).

12. The apparatus according to claim 11, the apparatus further comprising:
a second receiver configured to receive a response for indicating that the first AI/ML module and/or the second AI/ML module are/is to be stopped.

13. The apparatus according to claim 11, wherein the second transmitter is further configured to transmit, to the terminal equipment, timing information for stopping the first AI/ML module and/or the second AI/ML module.

14. The apparatus according to claim 13, wherein the timing information is transmitted via control information and/or data information; the control information comprises at least one of main information block (MIB), system information block (SIB), or downlink control information (DCI); and/or,
the timing information is configured via radio resource control message and is activated via media access control (MAC) control element (CE) or downlink control information (DCI); and/or,
the timing information is indicated via at least one of RRC configuration or reconfiguration, MAC CE activation or deactivation, or DCI activation or deactivation; and/or,
the timing information is transmitted via physical downlink shared channel (PDSCH) and the response of the timing information is an acknowledge (ACK) of the PDSCH.

15. The apparatus according to claim 13, wherein the timing information comprises stopping time and/or step time of the first AI/ML module and/or the second AI/ML module.

16. The apparatus according to claim 11, wherein the second processor circuitry determines the first AI/ML module and/or the second AI/ML module are/is to be stopped according to one or more signals from the terminal equipment and/or one or more parameters of the network device;
the second processor circuitry is further configured to stop the second AI/ML module in the network device; wherein the first AI/ML module in the terminal equipment and the second AI/ML module in the network device are stopped synchronously.

17. The apparatus according to claim 11, wherein the first AI/ML module and/or the second AI/ML module are/is used for channel state information (CSI) measurement;
the second processor circuitry is further configured to synchronize running or stopping the first AI/ML module and/or the second AI/ML module by using at least one of radio resource control message, media access control (MAC) control element (CE), or downlink control information (DCI).

18. The apparatus according to claim 17, wherein
for periodic CSI reporting, the second processor circuitry is configured to synchronize running the first AI/ML module and/or the second AI/ML module when CSI report configuration with AI/ML related information is configured, and/or, synchronize stopping the first AI/ML module and/or the second AI/ML module when CSI report configuration without AI/ML related information is configured.

19. The apparatus according to claim 17, wherein
for semi-persistent CSI reporting or aperiodic CSI reporting, the second processor circuitry is configured to synchronize running the first AI/ML module and/or the second AI/ML module when an AI/ML related CSI report is activated by MAC CE and/or DCI, and/or, synchronize stopping the first AI/ML module and/or the second AI/ML module when an AI/ML related CSI report is deactivated by MAC CE and/or DCI.

20. A network system, comprising:
a terminal equipment configured to determine a first AI/ML module in a terminal equipment and/or a second AI/ML module in a network device are/is to be stopped; and transmit to the network device a request for indicating to stop the first AI/ML module and/or the second AI/ML module; and/or
a network device configured to determine a first AI/ML module in a terminal equipment and/or a second AI/ML module in a network device are/is to be stopped; and transmit to the terminal equipment a request or a configuration or a signal for indicating to stop the first AI/ML module and/or the second AI/ML module.
